(19) United States
(12) Patent Application Publication
(10) Pub. No.: US 2026/0162220 A1
(43) Pub. Date: Jun. 11, 2026

(54) Detail Capture During Video

(71) Applicant: Axon Enterprise, Inc., Scottsdale, AZ (US)

(72) Inventors: Juha Alakarhu, Tampere (FI); Jesse Hakanen, Tampere (FI); David B. Mesri, Paradise Valley, AZ (US); Matti Suksi, Tampere (FI)

(21) Appl. No.: 19/411,095

(22) Filed: Dec. 5, 2025

Related U.S. Application Data
(60) Provisional application No. 63/729,278, filed on Dec. 6, 2024.

(51) Int. Cl. G06T 5/20; G06T 3/40; G06T 7/13; G06T 7/70; G06V 10/25

(52) U.S. Cl. CPC G06T 5/20; G06T 3/40; G06T 7/13; G06T 7/70; G06V 10/25; G06T 2207/20132; G06V 2201/07

(57) ABSTRACT

A recording device is worn by a user at an incident and is configured to capture video data. During an incident, responsive to the recording device receiving an input to capture a detail frame of an object of interest, the recording device determines a detail boundary to capture a detail frame having increased pixel density and reduced field of view. Image data may be processed by an image processing module via a single configuration for video capture and detail frame capture.

### FIELD OF INVENTION

Embodiments of the present invention relate to camera systems and modifying image capture during video.

### BACKGROUND

Personnel such as law enforcement officers, first responders, firefighters, and recreationalists use cameras to capture events, so that a video and/or audio record exists regarding what happened in an incident. These cameras may be mounted on vehicles such as cars and drones, and they may also be worn on the body as body-worn cameras. Numerous mounting systems exist to mount cameras to personnel. These systems include a variety of data capture settings and methodologies for recording videos, capturing images, and generally preserving optical information from a scene.

### BRIEF DESCRIPTION OF THE DRAWINGS

FIG. 1 depicts an example architecture for a recording device, according to some embodiments.

FIG. 2A depicts an example process for capture of incident information and generation of a detail frame, according to some embodiments.

FIG. 2B depicts an example process for capture of incident information and generation of a detail frame, according to some embodiments.

FIG. 2C depicts an example process for capture of incident information and generation of a detail frame, according to some embodiments.

FIG. 2D depicts an example process for capture of incident information and generation of a detail frame, according to some embodiments.

FIG. 3 depicts an example operating diagram for processing of video information and detail frame image by a recording device, according to some embodiments.

FIG. 4A depicts an example process for capture of incident information and generation of a detail frame, according to some embodiments.

FIG. 4B depicts an example process for capture of incident information and generation of a detail frame, according to some embodiments.

FIG. 4C depicts an example process for capture of incident information and generation of a detail frame, according to some embodiments.

FIG. 4D depicts an example process for capture of incident information and generation of a detail frame, according to some embodiments.

FIG. 5A depicts an example operating diagram for processing of video information and detail frame image by a recording device, according to some embodiments.

FIG. 5B depicts an example operating diagram for processing of video information and detail frame image by a recording device, according to some embodiments.

FIG. 6 depicts an example method for capturing a detail frame by a recording device, according to some embodiments.

FIG. 7 depicts an example flowchart for capturing a detail frame by a recording device, according to some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Additionally, any reference to without contact (or similar phrases) may also include reduced contact or minimal contact.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

In various embodiments, an electronic circuit of an electronic device may be configured as a processor that comprises any circuitry and/or electrical/electronic subsystem for performing a function of the electronic device and/or an operation of the electronic device discussed herein. For example, the processor may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, the processor may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, the processor may include data buses, output ports, input ports, timers, memory, arithmetic units, and/or the like.

The processor may be configured to provide and/or receive electrical signals whether digital and/or analog in form. The processor may provide and/or receive digital information via a data bus using any protocol. The processor may receive information, manipulate the received information, and provide the manipulated information. The processor may store information and retrieve stored information. Additionally, the processor may be associated with an amount of memory that is utilized by the processor to store information and retrieve stored information from within. Information received, stored, and/or manipulated by the processor may be used to perform a function, control a function, and/or to perform an operation or execute a stored program.

The processor may control the operation and/or function of other circuits and/or components of a recording device (e.g., the electronic device). The processor may receive status information regarding the operation of other components, perform calculations with respect to the status information, and provide commands (e.g., instructions) to one or more other components. The processor may command another component to start operation, continue operation, alter operation, suspend operation, cease operation, or the like. Commands and/or status may be communicated between the processor and other circuits and/or components via any type of bus (e.g., SPI bus) including any type of data/address bus.

In various embodiments, an amount of memory may comprise a tangible, non-transitory computer-readable memory. Instructions stored on the tangible non-transitory memory may allow an associated processor and/or other processing circuits to perform various operations, functions, and/or steps associated with a device. For example, in response to the processor executing the instructions on the tangible non-transitory memory, the processor may communicate with image capture modules to capture image data, audio capture modules to capture audio data, initiate capture of image data and/or audio data, end capture of the image data and/or audio data, and/or the like, as discussed further herein. Additionally, the amount of memory may also be configured to receive, store, and maintain incident recordings, including captured image data and audio data. In that regard, the memory may include a storage medium, data structure, database, memory unit, hard-disk drive (HDD), solid state drive (SSD), removable memory, and/or the like.

In various embodiments, a “memory unit” as discussed herein may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like. It should be noted that any memory unit, storage component, and/or amount of memory may utilize data structures and/or databases that include relational, hierarchical, graphical, distributed ledger, blockchain, object-oriented structure, and/or any other data storage configurations. Additionally, data structures and/or databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

In various embodiments, a database, system, device, server, amount of memory, memory unit, or other data storage components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

In various embodiments, “user interfaces” may comprise input devices that utilize hardware and/or software used to provide data, inputs, control signals, and the like to a computer-based system, software application, etc. For example, a user interface configured as an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device. Additionally, various user interfaces can be associated with receiving inputs from a user and/or providing indications to the user. For example, user interfaces can be configured to receive indications from the user via buttons, switches, levers, toggles, dials, sliders, and/or other mechanisms that are associated with a set of inputs.

In various embodiments, “user interfaces” may comprise output devices that utilize hardware and/or software configured to convert information into a human-accessible form, for display, projection, or physical reproduction. For example, a user interface configured as an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a printer (e.g., dot matrix printer, inkjet printer, laser printer, 3D printer, wide-format printer, etc.), a braille reader, a composite device (e.g., a device having a plurality of different forms of output), and/or any other output device. Additionally, user interfaces can be configured to output indications to the user via speakers, screens, haptic feedback devices, and/or other mechanisms that are associated with a set of outputs. Further, user interfaces can be configured to both receive indications from and output indications to the user via touch screen interfaces, audio interfaces (e.g., verbal commands and responses), and/or other mechanisms associated with a set of inputs and a set of outputs.

In various embodiments, an incident (or similar terms and phrases, such as an emergency or event) refers to human or animal activities and to a period of time while these activities take place. An incident may include, for example, formation of agreements, transactions, negotiations, discussions, ceremonies, meetings, medical procedures, sporting events, crimes, attempted crimes, disagreements, assaults, conflicts, discoveries, research, investigations, surveillance, and/or the like. Additionally, an incident may be associated with and/or include consequences that occur as a result of, as an effect of, in relation to, and/or otherwise in association with the incident. For example, one or more consequences of an incident may include changes to property such as improvements, repairs, construction, production, manufacture, growth, harvesting, damage, loss, theft, burglary, arson, goods damaged in shipment, conditions of real estate, and/or conditions of agricultural and forestry property. Consequences associated with an incident may include damage to property and/or injury to persons or animals. Damage to property or injury to persons or animals may be accidental or brought on by the action or failure to act of one or more persons. Incidents may be associated with and/or include incident information that may be valuable or otherwise important, helpful, or needed for risk management, insurance, claims, achievements, sports records, news reporting, entertainment, and/or the like.

One or more incident responders may respond or help before, during, or after an incident. For example, in response to an incident including a fire (e.g., burning building, house fire, etc.), incident responders may typically include a law enforcement officer, a firefighter, and/or a medical responder (e.g., an emergency medical technician (EMT), a paramedic, an ambulance technician, etc.). As a further example, in response to an incident including a crime or attempted crime, incident responders may include one or more law enforcement officers.

Incident information (e.g., qualitative data, quantitative data, audio information, visual information, location information, environmental information, etc.) is gathered by individuals, incident responders, devices, and/or other recording means and is associated with an incident. Additionally, incident information may include descriptions, opinions, testimony, and/or other statements regarding the incident. Further, incident information may include facts about the activities of the incident, consequences of the incident, time of the incident, and identities associated with humans, animals, or objects related to the incident. Incident information may be recorded as and/or form a report a report of an incident (e.g., an incident report). Incident information about the incident may be gathered before, during, or after an incident. Incident information may be recorded (e.g., audio, video) to document an incident at the time of occurrence.

Incident recording may capture at least a set of incident information associated with the incident. Incident recording further protects against loss of incident information, for example, by physical loss or by faulty human memory. For example, incident responders may capture audio and/or visual information of the incident. The audio and/or visual information may be captured by an incident recording device, such as, for example, a body-worn camera, a smart phone or internet of things (IoT) device, a vehicle-mounted camera, a surveillance camera, and/or any other recording device discussed herein. The recording device may be physically located at a scene of the incident to capture the information about the incident.

An incident recording device may capture incident information from a fixed position (e.g., a fixed field of view, a fixed vantage point, etc.). A fixed position may comprise a position that does not follow or align with a field of view or perception of an incident responder during the incident. The fixed position may be defined relative to an object to which the recording device is attached. For example, a body-worn camera may capture a fixed position from the body of the incident responder, a vehicle-mounted camera may capture a fixed position from the vehicle, etc. The fixed position may include information that is not within the visual perspective (e.g., visual point of view) of the incident responder. The fixed position may not capture all information that is within the visual perspective of the incident responder. For example, the responder may turn their head, resulting in a misalignment between a direction (e.g., forward direction) of a fixed field of view of a chest-mounted body worn camera and the direction (e.g., lateral or vertical direction) of the visual point of view of the responder.

An incident recording device may capture incident information from a dynamic position (e.g., a dynamic field of view, a dynamic vantage point, etc.). A dynamic position may comprise a position that moves, changes, and/or otherwise alters a field of view and/or perception during the incident. Alternatively, or in additionally, the dynamic position may comprise a position that follows and/or aligns with a field of view or perception of an incident responder during the incident. The dynamic position may be defined relative to an object to which the recording device is attached. For example, a body-worn camera may capture a dynamic position aligned to an incident responder field of view by being mounted to a head of the incident responder. The dynamic position may include information that is not within the visual perspective (e.g., visual point of view) of the incident responder (e.g., the incident recording device comprises a fish-eye lens and/or a 360-degree lens to capture information not within the visual perspective of the incident responder). The dynamic position may not capture all information that is within the visual perspective of the incident responder.

In the following description and throughout the disclosure, the terms “recording device” and “camera” may be used interchangeably. It will be apparent to one skilled in the art that each of these terms refers to a device capable of capturing one or more of video, audio, and/or image data and transmitting the video, audio, and/or image data via a communications network.

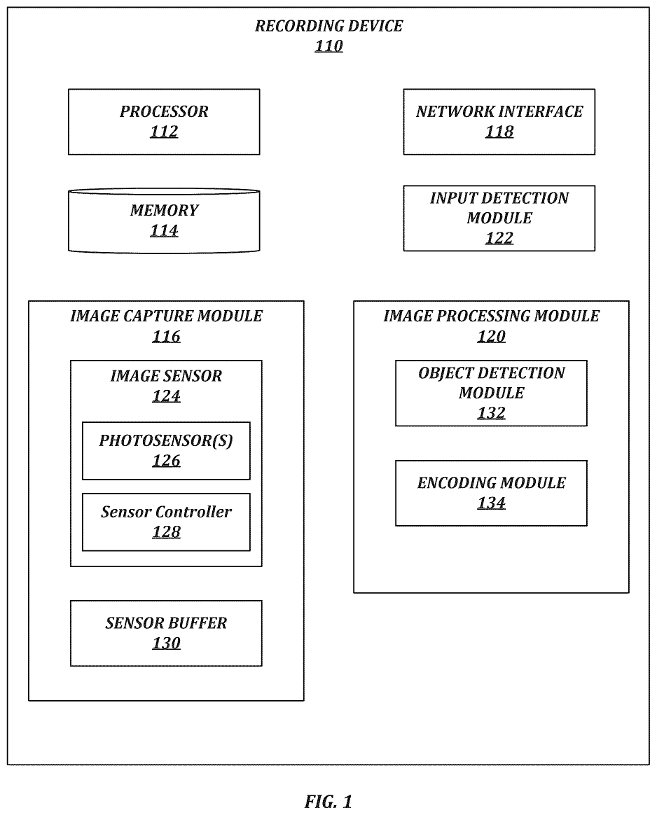

In various embodiments, and with reference to FIG. 1, an exemplary recording device 110 is disclosed. Recording device 110 may comprise any suitable device configured to capture incident information. Recording device 110 may comprise a camera. For example, recording device 110 may comprise a body-worn camera, an in-vehicle camera, a smart phone, or the like. In various embodiments, recording device 110 comprises a body configured to house (fully and/or at least partially) various mechanical, electrical, and/or electronic components configured to aid in performing the functions of recording device 110.

In the example embodiment of FIG. 1, recording device 110 comprises processor 112, memory 114, image capture module 116, network interface 118, image processing module 120, input detection module 122, and/or other recording device components. In various embodiments, recording device 110 may comprise additional or fewer modules, and processes performed by one or more modules described herein may be in part or in whole performed by other modules or entities of a larger recording system associated with recording device 110. Alternatively, or in addition, recording device 110 may be associated with one or more remove devices and/or cloud platforms that perform one or more processes described herein. In embodiments, components of recording device 110 may be disposed in a same housing. For example, two or more of processor 112, memory 114, image capture module 116, network interface 118, image processing module 120, and/or input detection module 122 may be disposed in a same housing.

In various embodiments, the processor 112 may be configured as a processing circuit that performs, triggers, manages, and/or otherwise operates various functions associated with the recording device 110. In particular, the processor 112 may be configured to execute a rule set for managing one or more inputs received via one or more user interfaces to perform the various functions associated with the recording device 110. The processor 112 may be configured to provide and receive electrical signals (e.g., digital signals, analog signals, etc.) that enable performance of the various functions. Additionally, the processor 112 may be configured to access indications stored in memory 114 and/or available via network interface 118. Further, processor 112 may be configured to control operation of various components of recording device 110, image capture module 116, image processing module 120, input detection module 122, one or more user interfaces, and/or other components associated with recording device 110.

In various embodiments, the memory 114 may comprise one or more memory structures, data structures, or the like configured to store data, programs, and/or instructions. Memory 114 may be configured to receive and/or store one or more indications received from processor 112, image capture module 116, network interface 118, image processing module 120, input detection module 122, and/or other module associated with recording device 110. Additionally, memory 114 may be accessed by various components of the recording device 110 to acquire the one or more indications stored by memory 114.

In various embodiments, the network interface 118 may be configured to enable the transmission and/or reception of data between recording device 110 and one or more additional devices, servers, networks, or the like. For example, the network interface 118 may be configured to enable the transmission and/or reception of data between recording device 110 and an auxiliary recording device of a recording system associated with recording device 110. The network interface 118 may be in electric and/or electronic communication with the processor 112 and/or the memory 114. The network interface 118 may comprise one or more suitable hardware and/or software components capable of enabling the transmission and/or reception of data, such as, for example, a communications unit, a transmitter, and/or a receiver. In various embodiments, recording device 110 may have a receiver configured to receive data (e.g., images, video, etc.) from an auxiliary recording device and/or other entities of the recording system associated with recording device 110. In various embodiments, recording device 110 may have a transmitter and a receiver to transmit data (e.g., instructions) to and receive data (e.g., images, video, etc.) from an auxiliary recording device and/or other entities of the recording system 100.

In various embodiments, image capture module 116 may be configured to capture optical information for recording (e.g., saving, storing, and/or otherwise preserving) an image or series of images (e.g., video). For example, during an incident recording, image capture module 116 may be configured to capture optical information utilized to generate an image or series of images of the incident recording. Image capture module 116 may comprise various hardware and/or software components configured to collect and/or capture optical information associated with an incident. For example, image capture module 116 may comprise one or more image sensors, one or more optical elements, and/or buffer storage configured to store digital and/or analog signals from one or more image sensors. An image sensor of the one or more image sensors may capture narrow angle field of view, a wide angle field of view, and/or the like.

In various embodiments, one or more optical elements of image capture module 116 may comprise one or more camera lenses (e.g., a multi-lens image capture module). For example, image capture module 116 may comprise a forward capture lens configured to capture optical information from a field of view that is at least partially forward the user. Similarly, image capture module 116 may comprise a rearward capture lens configured to capture optical information from an additional field of view that is at least partially rearward the user. An image capture module 116 may also comprise one or more side or profile capture lenses configured to capture optical information from a further field of view that is peripheral the user. Processor 112 of recording device 110 may coordinate with the plurality of camera lenses to capture images at a same time, or near same time. The one or more optical elements, in combination with one or more image sensors of image capture module 116, may be configured to capture an image having a narrow angle field of view or a wide angle field of view.

In various embodiments, image capture module 116 may comprise an omnidirectional image capture module. The omnidirectional image capture module may be configured to capture a 360 degree field of view relative to the body of recording device 110. The omnidirectional image capture module may comprise a camera lens having a 360 degree field of view, or a plurality of camera lenses enabling a 360 degree field of view. The omnidirectional image capture module may be configured to output images and/or series of images as monoscopic video or stereoscopic video.

In various embodiments, image capture module 116 may comprise an infrared image capture module. The infrared image capture module may comprise any suitable infrared image capture module, including short wavelength infrared (SWIR), medium wavelength infrared (MWIR), and/or long wavelength infrared (LWIR). The infrared image capture module may be configured to detect infrared energy (heat), convert the detected infrared heat into an electronic signal, and process the electronic signal to produce a thermal image.

Image capture module 116 may be in electric and/or electronic communication with the processor 112 and/or the memory 114. Processor 112 may control (e.g., instruct) image capture module 116 to begin capturing images and to end capturing of the images. The processor may also control (e.g., instruct) image capture module 116 to transmit the captured images to memory 114 for storage. Image capture module 116 may transmit (e.g., stream) the captured images to the memory 114 as the images are captured or in response to image capture module 116 ending capturing of the images.

In various embodiments, recording device 110 may not comprise an image capture module. In that regard, in order to capture images of an incident recording device 110 may communicate with an auxiliary recording device configured to capture images. Alternatively, recording device 110 may comprise image capture module 116 and may communicate with the auxiliary recording device to capture optical information from a plurality of perspectives. The auxiliary recording device may comprise an image capture module. In various embodiments, the auxiliary recording device may comprise a body or housing separate from the body or housing of recording device 110. The auxiliary recording device may comprise a body or housing detachable from the body or housing of recording device 110, or may be in wired or wireless connection with recording device 110.

In various embodiments, image capture module 116 may be configured to collect optical information via image sensor 124. Optical information may comprise photons that are received from an incident (e.g., an incident scene, an incident location, an incident event, etc.) via optical elements of image capture module 116. The optical elements may direct optical information from the incident onto photoreceptors of image sensor 124 where the optical information is converted into digital and/or analog signals. The digital and/or analog signals may be stored via sensor buffer 130 prior to processing by image processing module 120.

In various embodiments, image sensor 124 may comprise a plurality of photosensors 126 (e.g., photoreceptors, optical detectors, light sensors, etc.) that are arranged to capture optical information received via one or more optical elements. In particular, the plurality of photosensors 126 may be configured to capture optical information at a sensor resolution (e.g., a first resolution, a capture resolution, a received resolution, etc.). Additionally, image sensor 124 may be configured such that the plurality of photosensors 126 capture optical information at one or more sensor resolutions determined for image sensor 124. For example, image sensor 124 may be configured as a 4k sensor (e.g., captures optical information at a sensor resolution of 3840 pixels by 2160 pixels), the 4k sensor comprising the plurality of photosensors 126 arranged to capture optical information at the sensor resolution. Further, image sensor 124 may be configured to capture optical information at one or more sensor resolutions (e.g., 4k, 2k, 1080p, 720p, 1080i, etc.). It should be noted that image sensor 124 may comprise a set of photosensors 126 that capture optical information for each individual pixel of the sensor resolution. Additionally, the image sensor 124 may comprise variable sets of photosensors 126 for individual pixels of the sensor resolution. Generally, the plurality of photosensors 126 may be arranged to form image sensor 124 capable of capturing optical information at the sensor resolution.

In various embodiments, image sensor 124 may provide optical information to sensor buffer 130. In particular, image sensor 124 may receive optical information associated with the incident and convert the optical information into digital and/or analog signals. The digital and/or analog signals may be stored within sensor buffer 130 prior to image processing model 120 encoding the digital and/or analog signals as one or more images. Sensor buffer 130 may be configured as volatile and/or non-volatile memory. In some embodiments, sensor buffer 130 may be configured as transitory storage for the digital and/or analog signals between capture by image sensor 124 and recording as the one or more images. Accordingly, image sensor 124 may convert optical information into digital and/or analog signals that are stored in sensor buffer 130 as image data.

In various embodiments, image sensor 124 may comprise a plurality of photosensors 126 that are operated via at least a sensor controller 128. In particular, the plurality of photosensors 126 may define sensor dimensions of image sensor 124. The plurality of photosensors 126 may be arranged to form image sensor 124, the sensor dimensions being equal to a full sensor resolution at which optical information may be captured. For example, the plurality of photosensors 126 may be arranged to form image sensor 124 such that image sensor 124 comprises an array of photosensors having dimensions of 4512 photosensors by 2512 photosensors. As a result, the full sensor resolution of images captured by image sensor 124 would be 4512 pixels by 2512 pixels. It should be noted that while the above example specifies a set of dimensions for image sensor 124, it should not be interpreted as a limit to the dimensions of image sensor 124 or a floor for the dimensions of image sensor 124. Instead, the plurality of photosensors 126 may be arranged in any combination. Similarly, the plurality of photosensors may be arranged in a variety of packing organizations including grid organization, hexagonal organization, and other photosensor organizations.

In various embodiments, sensor controller 128 may control capture of optical information by image sensor 124 and the plurality of photosensors 126. In particular, image sensor 124 may capture optical information based at least on a sensor configuration implemented via at least sensor controller 128. Sensor controller 128 may cause a subset of the plurality of photosensors 126 to capture optical information based at least on the sensor configuration. Additionally, the sensor configuration may cause sensor controller 128 to control the plurality of photosensors 126 to capture optical information at a sensor resolution, the sensor resolution less than or equal the full sensor resolution for image sensor 124. Further, the sensor configuration may comprise initial processing indications for optical information captured by image sensor 124. For example, the sensor configuration may indicate that the sensor resolution for image capture and/or video capture is 4K resolution. In response to a capture indication, the sensor controller 128 may at least partially cause a subset of the plurality of photosensors 126 to capture optical information at the sensor resolution, the subset of the plurality of photosensors 126 determined by sensor controller 128 based at least on the sensor resolution of the sensor configuration. As a result, the subset of the plurality of photosensors 126 may capture optical information and sensor controller 128 may implement initial processing indicated by the sensor configuration. The initial processing may include a binning operation that modifies the optical information from the sensor resolution to an output resolution. Sensor configuration may comprise indications of the sensor resolution, the initial processing operation(s) to be applied to captured optical information, and/or the output resolution for optical information being provided to sensor buffer 130 and/or image processing module 120.

In various embodiments, sensor controller 128 may be configured to manage one or more actions associated with capturing optical information. The one or more actions may comprise filtering actions. For example, sensor controller 128 may configure image sensor 124 to apply a first filter and apply a second filter. The operations of the first filter and second filter may be performed at different times. Captured image day may be applied to either a first filter or a second filter in accordance with various embodiments. Sensor controller 128 may determine the sensor resolution and/or the subset of the plurality of photosensors 126. Sensor controller 128 may cause the subset of the plurality of photosensors 126 to capture the optical information. Sensor controller 128 may be configured to determine one or more parameters for a crop operation. The crop operation may be utilized to select a portion of the optical information captured by at least the subset of the plurality of photosensors 126. The subset of the plurality of photosensors 126 may comprise fewer photosensors than a set of the plurality of photosensors 126 by which optical information was previously captured. The subset of the plurality of photosensors 126 may comprise less than all of the plurality of photosensors 126 by which optical information may be captured. For example, a first sensor configuration associated with a binning operation may involve a first set of photosensors by which first optical information is captured, while a second sensor configuration associated with a cropping operation may involve another, second set of the photosensors by which second optical information may be captured. The photosensors of the plurality of overall photosensors in the second set may be different that the photosensors of the overall photosensors in the first set. The second set may comprise fewer photosensors that the first set. The second subset may comprise a subset of the first set. Photosensors included in the first set may be excluded or not selected for the second set. The first and second set may differ in accordance with the different sensor configurations. Applying a second filter may comprise cropping a first amount of data that may be captured by image sensor 124. Sensor controller 128 may be configured to determine a capture offset where the subset of the plurality of photosensors 126 is displaced from a default position associated with image sensor 124. Sensor controller 128 may be configured to cause a binning operation to occur, the binning operation modifying the optical information captured by at least the subset of the plurality of photosensors 126 from the sensor resolution to an output resolution. Applying a first filter may comprise binning data captured by a set of the plurality of photosensors 126 to decrease a resolution of the data. Generally, the sensor configuration may comprise one or more indications for enabling and/or causing sensor controller 128 to manage operations of image sensor 124 to capture the optical information. In embodiments, each of a crop operation and a binning operation may reduce a resolution of data to which the operation is respectively applied, though in different manners. Cropping may comprise removing or not capturing a first subset of data at a first resolution, while retaining a second subset of the data to provide data at a second resolution. Cropping may retain an original amount of information density within the second subset of the data. In contrast, binning may comprise reducing a resolution of data across an entirety of the data at the first resolution to provide data at the second resolution by reducing information density. Both operations may generate image data representing a portion of a field of view. Binning may reduce the image data from the first resolution to the second resolution by combining signals from the set of photoreceptors to generate the second subset of data. Cropping may reduce the image data from the first resolution to the second resolution by determining the subset of photoreceptors that corresponds to the second subset of data. Generally, the cropping operation may provide a higher level of detail within a portion of the field of view than the binning operation.

Image processing module 120 may apply one or more processing algorithms to image data captured by image capture module 116. Image processing module 120 may receive image data from image sensor 124 and/or sensor buffer 130. Additionally, image processing module 120 may utilize the image data to generate one or more images at a recording resolution (e.g., a second resolution, an image resolution, a video resolution, etc.). Further, image processing module 120 may modify and/or analyze the image data. For example, image processing module 120 may adapt brightness and/or stabilization of image data, may apply object recognition algorithms to image data, or the like. In other examples, image processing module 120 may modify or apply other processes or algorithms to image data, such as, for example, modifying an aspect ratio, modifying the recording resolution, modifying how one or more images are encoded, modifying a file type, or the like.

In some embodiments, image processing module 120 may comprise object detection module 132. In particular, object detection module 132 may be configured to apply one or more object recognition algorithms to image data received and/or obtained from sensor buffer 130. Additionally, object detection module 132 may be configured to apply one or more locating algorithms to determine placement of one or more objects within the image data. Similarly, object detection module 132 may be configured to apply one or more prioritization algorithms to assign priority for one or more objects within the image data.

In various embodiments, image processing module 120 may comprise encoding module 134. In particular, encoding module 134 may comprise one or more algorithms for converting the digital and/or analog signals stored as image data via sensor buffer 130 into one or more images (e.g., individual images, a video, a combination of image and video, etc.).

In various embodiments, input detection module 122 may receive one or more inputs from a user of recording device 110 and perform one or more actions based in part on the one or more inputs. Input detection module 122 may comprise one or more buttons, touch interfaces, audio interfaces (e.g., microphones), accelerometer, and the like. Alternatively, or in addition, input detection module 122 may be a virtual module that comprises a set of instructions executed by processor 112 to evaluate inputs received from one or more user interfaces. Inputs may comprise for example, button presses, voice inputs, and/or other interactions with an interface of recording device 110, the inputs configured to cause the recording device to perform an action, such as beginning or ending video data capture, transmitting captured video data, storing, processing, or modifying captured video data, or the like.

In various embodiments, recording device 110 may be paired with one or more computing devices that perform one or more of the above functions and/or are utilized in place of (or in combination with) one or more modules described above. In particular, the one or more computing devices may comprise any suitable device configured to receive and process video data. For example, the one or more computing devices may comprise a laptop computer, desktop computer, mobile phone, or other computing device. Alternatively, or in addition, the one or more computing devices may comprise a server and/or datastore. In various embodiments, the one or more computing devices may be housed within one or more bodies configured to enclose (fully and/or at least partially) various mechanical, electrical, and/or electronic components configured to aid in performing the functions of the one or more computing devices and/or recording device 110.

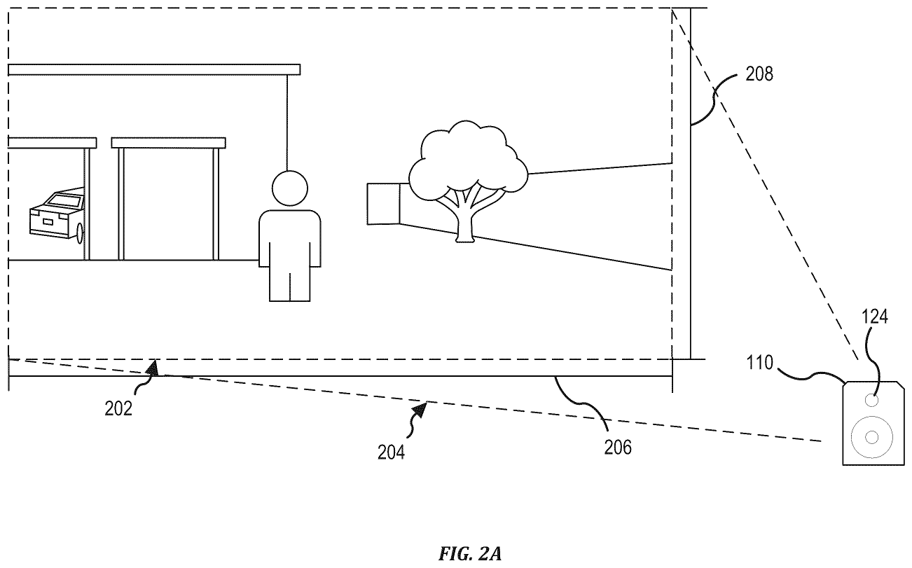

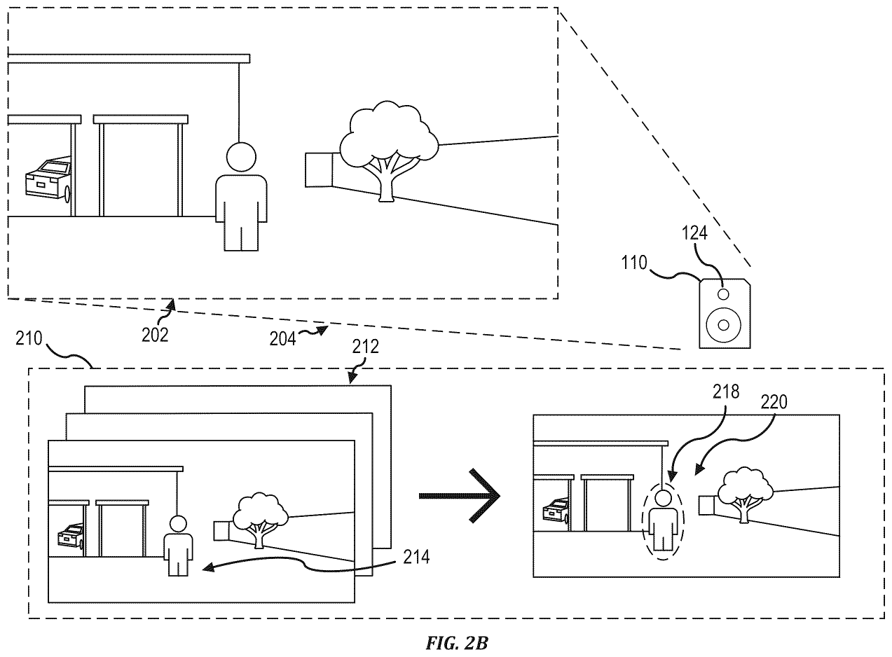

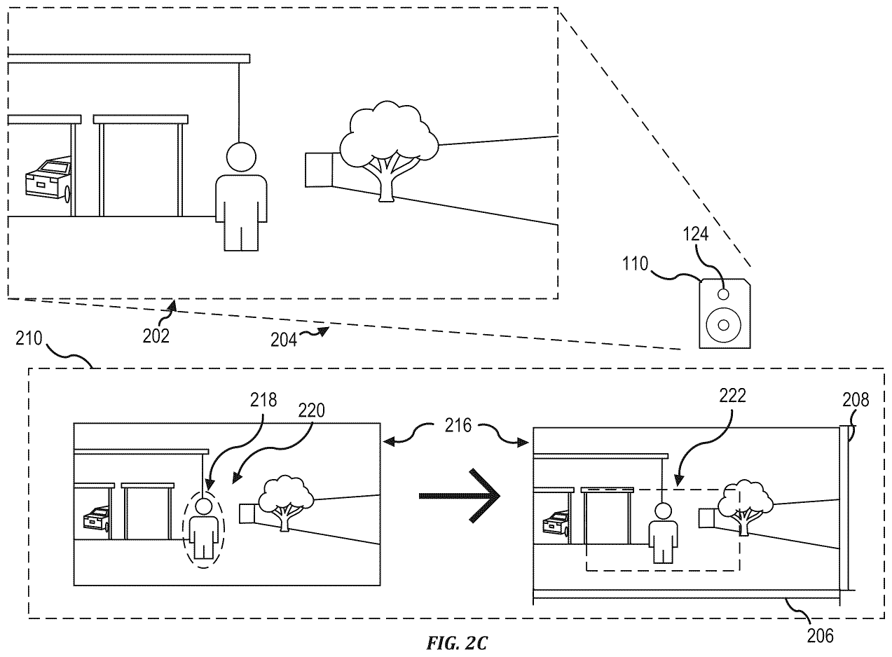

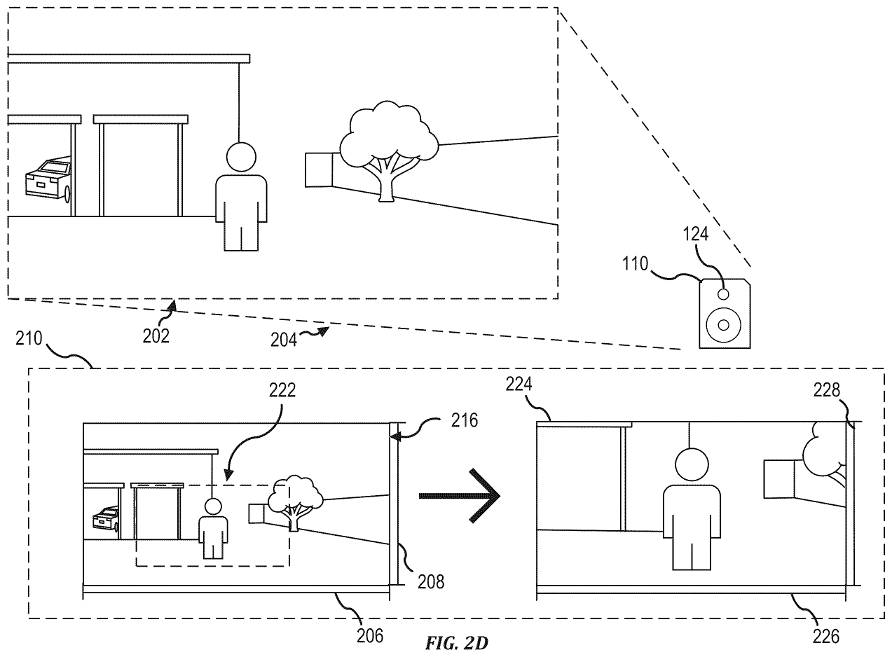

In various embodiments, and with reference to FIGS. 2A-2D, a recording device for capturing a detail frame is described. In particular, the recording device depicted by FIG. 2 may represent recording device 110, other recording devices and/or other computing devices utilized as a recording system. As previously noted, recording device 110 may be configured to capture a visual point of view at least partially aligned with a point of view of the incident responder. Alternatively, the recording device may be configured to capture a visual point of view unassociated with the point of view of the incident responder (e.g., mounted to a vehicle associated with the incident responder).

In various embodiments, and with reference to FIG. 2A, recording device 110 may comprise image sensor 124 for capturing an incident scene 202. In particular, recording device 110 may be mounted to an incident responder, a responder vehicle, and/or other mounting point such that image sensor 124 is able to capture optical information of incident scene 202. Image sensor 124 may be associated with a field of view 204 that enables image sensor 124 to collect, obtain, gather, and/or otherwise receive optical information of incident scene 202. Additionally, image sensor 124 may be continuously exposed to optical information from field of view 204. In response, image sensor 124 may be activated by recording device 110 and store optical information as image data within a sensor buffer (e.g., sensor buffer 130). Alternatively, or in addition, image sensor 124 may be selectively exposed to optical information from field of view 204 (e.g., via a shutter system). Independent of how image sensor 124 is exposed to optical information from incident scene 202, image sensor 124 may capture optical information as image data on a periodic, aperiodic, triggered (e.g., by user input, by external signal, by internal determination, etc.), and/or other basis. Further, the image data captured from the optical information may correspond to a single image (e.g., a picture) and/or a plurality of images (e.g., a video).

In various embodiments, recording device 110 may be configured to continuously capture image data via image sensor 124. In particular, image sensor 124 may capture image data from incident scene 202 at discrete intervals. The interval for capturing image data may be associated with a video frame rate (e.g., 30 frames per second, 60 frames per second, 144 frames per second, etc.), a refresh rate of image sensor 124 (e.g., a field rate for interlaced image data, a rate at which image sensor 124 captures image data, etc.), and/or other capture rate associated with image sensor 124. Image data may be timestamped and/or otherwise flagged to provide a sequence for arranging one or more images generated by an image processing module (e.g., image processing module 120). Alternatively, image data may be comprised of one or more portions that are ordered in sequence of the one or more images generated by the image processing module.

In various embodiments, recording device 110 may be configured to capture image data based at least on one or more inputs received by recording device 110. In particular, image sensor 124 may capture image data and store the image data via the storage buffer based at least on the one or more inputs. The one or more inputs may comprise a user input that is received via a user interface indicating that an image is to be captured (e.g., taking a picture). The one or more inputs may comprise a user input that is received via a user interface indicating that a set of images is to be captured (e.g., taking a plurality of pictures, begin recording a video, etc.). In response to recording device 110 receiving the user input to begin recording a video, the recording device may receive an additional user input that ends recording of the video. Additionally, or alternatively, the one or more inputs may comprise an external signal that is received from a remote device associated with recording device 110. The external signal may be received and indicate that the remote device has been drawn, activated, discharged, is in proximity to recording device 110, and/or otherwise has changed state and/or relationship to recording device 110. Receipt of the external signal may cause image sensor 124 to capture image data for one or more pictures and/or initiate video recording.

In various embodiments, recording device 110 may be configured to capture image data based at least on an internal signal of the one or more inputs. In particular, image sensor 124 may capture image data and store the image data via the storage buffer based at least on the internal signal. The internal signal may be received from a processor of the recording device 110, an object detection module of the recording device 110, and/or other component of the recording device 110. The internal signal may be received by recording device 110 based at least on a component of recording device 110 detecting that one or more conditions have been identified in and/or are satisfied by the image data. It should be noted that the determination for whether the internal signal is to be generated may be triggered by a user input and/or external signal.

In various embodiments, recording device 110 may be configured to capture image data from field of view 204. In particular, image sensor 124 may capture image data at a sensor resolution having a horizontal dimension 206 and a vertical dimension 208. Photoreceptors of image sensor 124 may be arranged such that image data is captured from field of view 204 having the horizontal dimension 206 and the vertical dimension 208.

In various embodiments, and with reference to FIG. 2B, recording device 110 may comprise image sensor 124 for capturing an incident scene 202. In particular, recording device 110 may be mounted to an incident responder, a responder vehicle, and/or other mounting point such that image sensor 124 is able to capture optical information of incident scene 202. Image sensor 124 may be associated with a field of view 204 that enables image sensor 124 to collect, obtain, gather, and/or otherwise receive optical information of incident scene 202. Optical information from incident scene 202 may be captured by image sensor 124 as image data that is stored within a sensor buffer. Image data captured by image sensor 124 may be utilized by image processing module 210 to produce a set of images 212.

In various embodiments, image processing module 210 may be configured as one or more modules, logical structures associated with a processor of recording device 110, physical component(s) of recording device 110, and/or other image signal processing pipeline. In particular, image processing module 210 may execute one or more operations for converting the image data stored within the sensor buffer into the set of images. Image processing module 210 may perform evaluation of color for individual pixels within the set of images, demosaicing, image sharpening, noise reduction, and other operations for converting the digital and/or analog signals from individual photoreceptors into the set of images 212. It should be noted that the methodology of converting image data captured by image sensor 124 (e.g., CCD sensors, CMOS sensors, NMOS sensors, MOS devices, MOSFET devices etc.) may be performed according to known techniques.

In various embodiments, image processing module 210 may be configured to perform object recognition. Alternatively, a module (e.g., an object recognition module) associated with image processing module 210 may be configured to perform object recognition. In particular, image processing module 210 may comprise an object recognition module configured to identify objects in the set of images 212 captured by image sensor 124 and field of view 204. For example, image recording device 110 may capture the set of images 212 of an incident scene 202. Within incident scene 202 there may be a plurality of objects. Image recording device 110 may be configured to identify objects of interest within the incident scene 202 and field of view 204 captured by the set of images. The object recognition module of image processing module 210 may be configured to analyze the set of images and determine whether the images contain one or more objects of interest.

In various embodiments, an indication may be provided to image processing module 210 and/or an object detection module to initiate an object of interest detection mode. In particular, the indication may cause image processing module 210 and/or the object detection module to detect one or more objects in field of view 204. Additionally, the object of interest detection mode may cause image recording device 110 may determine whether the one or more objects in field of view 204 include one or more objects of interest. Alternatively, or in addition, the object of interest detection mode may cause image recording device 110 to determine that the one or more objects in field of view 204 do not include one or more objects of interest. As a result, image recording device 110 may continue object identification and evaluation until one or more objects of interest are identified within field of view 204. Further, and based at least on identification of one or more objects of interest within field of view 204, the one or more objects of interest may be utilized as one or more detail subjects 218.

In various embodiments, image processing module 210 may determine that the set of images 212 contain a first object of interest 214. In particular, image processing module 210 may determine that the set of images 212 contain the first object of interest 214 based at least on one or more qualifying features. The one or more qualifying features may be associated with a position of the object of interest within the field of view 204, a duration of the object of interest remaining in the field of view 204, whether the object of interest is highlighted by an incident responder and/or other individual associated with the incident scene, and/or other features associated with the object of interest while it is within the field of view 204. More specifically, image processing module 210 may be configured to recognize individual objects within the set of images 212. For example, image processing module 210 may detect vehicles, buildings, landmarks, flora, fauna, humans, streets, and/or other objects captured by the set of images 212. Image processing module 210 may detect multiple objects within field of view 204 and distinguish between individual objects based at least on one or more object attributes and/or features (e.g., object color/color scheme, accessories associated with the object, identifying features of the object, outline, profile, etc.).

In various embodiments, image processing module 210 may distinguish the first object of interest 214 from one or more additional objects captured by the set of images 212. In particular, one or more qualifying features of the first object of interest 214 may cause image processing module 210 to flag the first object of interest 214 as a detail subject 218 for a detail frame. For example, image processing module 210 may determine that an individual captured by the set of images 212 is the first object of interest 214. The individual may be identified as an object within the set of images 212 by image processing module 210 and flagged as the first object of interest 214. Image processing module 210 may flag the individual as the first object of interest 214 based at least on a ruleset associated with the image processing module 210. Alternatively, or in addition, the individual may be flagged as the first object of interest 214 based on field of view 204 tracking the individual to keep them approximately centered within the field of view 204. Additionally, the individual may be flagged as the first object of interest 214 based at least on the individual remaining within the field of view 204 for a threshold duration. Generally, a ruleset may be configured by a user and/or other individual associated with image recording device 210 to define the one or more qualifying features. Further, the ruleset may be configured to identify one or more types of objects that are to be flagged as objects of interest (e.g., vehicles, front ends of vehicles, rear ends of vehicles, humans, signage and/or iconography, address indicators, etc.).

In various embodiments, image processing module 210 may comprise a set of algorithms that are configured to determine whether an object is an object of interest. In particular, image processing modules 210 may utilize various algorithms configured to distinguish between baseline objects (e.g., trees, sides of buildings, vehicles incidentally caught within field of view 204, individuals incidentally caught within field of view 204, animals, structures, etc.) and objects of interest. The set of algorithms may include object detection algorithms, monitoring algorithms for tracking detected objects, machine learning algorithms, AI algorithms trained to recognize types of objects and/or object attributes, and/or other algorithms associated with the detection and determination of one or more objects of interest.

In various embodiments, image processing module 210 may determine that the first object of interest 214 is a detail subject 218 to be captured. In particular, detection and/or determination of the first object of interest 214 may cause image processing module 210 to flag the first object of interest for capture by a detail frame. Additionally, detection and/or determination of the first object of interest 214 as the detail subject 218 may comprise locating detail subject 218 within the field of view 204 of the camera and/or the one or more fields of view 216 of the set of images 212. Accordingly, image processing module 210 may determine a detail subject location 220 for detail subject 218 that approximates a position of the first object of interest 214 within incident scene 202.

In various embodiments, and with reference to FIGS. 2C and 2D, recording device 110 may comprise image sensor 124 for capturing an incident scene 202. In particular, recording device 110 may be configured to capture a detail frame of detail subject 218. Image sensor 124 may be associated with a field of view 204 that enables image sensor 124 to collect, obtain, gather, and/or otherwise receive optical information of incident scene 202. From the optical information, recording device 110 may generate a set of images 212 and/or determine a detail subject 218 captured by the set of images 212. Additionally, identification of a detail subject 218 may cause recording device 110 to determine a detail frame, associated with the detail subject 218, for capture.

In various embodiments, image processing module 210 may be configured to determine a bounding frame 222 for detail subject 218 based at least on detail subject location 220. In particular, image processing module 210 may determine a bounding frame that encloses the detail subject within the field of view 204 and/or the one or more fields of view 216. Field of view 204 (and/or the one or more fields of view 216) may have a horizontal dimension 206 and a vertical dimension 208 that equals the horizontal dimension 206 and vertical dimension 208 of image sensor 124. Alternatively, or in addition, field of view 204 (and/or the one or more fields of view 216) may have a horizontal dimension 206 and a vertical dimension 208 that equals the horizontal dimension 206 and vertical dimension 208 of a subset and/or a portion of image sensor 124 (e.g., the subset of the plurality of photosensors 126). For example, field of view 204 (and/or the one or more fields of view 216) may be defined such that horizontal dimension 206 is shared by the photoreceptors of image sensor 124 and field of view 204 (and/or the one or more fields of view 216). Similarly, field of view 204 (and/or the one or more fields of view 216) may be defined such that vertical dimension 208 is shared between the photoreceptors of image sensor 124 and field of view 204 (and/or the one or more fields of view 216). As a result, detail subject location 220 may have a corresponding position associated with image sensor 124. Additionally, detail subject location 220 may be utilized to determine bounding frame 222.

In various embodiments, image processing module 210 may be configured to convert image data captured by image sensor 124 into a set of images (e.g., set of images 212). In particular, image data is captured by image sensor 124 at a sensor resolution (e.g., a first resolution, a capture resolution, a received resolution, etc.), the sensor resolution having a horizontal dimension 206 and a vertical dimension 208. Additionally, image processing module 210 may receive the image data and utilize the image data to generate the set of images. Generating the set of images may include downscaling the sensor resolution to a recording resolution (e.g., a second resolution, a saved resolution, an image resolution, etc.). The sensor resolution may be downscaled to the recording resolution for improved power efficiency and reduced computation load (e.g., consolidating pixels may reduce memory read/write operations, image processing operations executed, computation required to manage the set of images, etc.). Further, the sensor resolution may be downscaled to the recording resolution for more efficient storage of the set of images.

In various embodiments, image processing module 210 may be configured to receive and/or obtain image data to generate the set of images. In particular, a first image processing pipeline may comprise receiving and/or obtaining image data at the sensor resolution of image sensor 124. Image processing module 210 may utilize the image data at the sensor resolution to generate the set of images at the recording resolution. Additionally, the first image processing pipeline of image processing module 210 may be a default, standard, and/or baseline operating state for image processing module 210.

In various embodiments, image processing module 210 and/or a module associated with the image processing module 210 may be configured to determine a bounding frame 222 for capturing a detail frame 224. In particular, determining that the first object of interest 214 is a detail subject 218 may initiate capture of a detail frame 224 of detail subject 218. For example, image processing module 210 may determine the detail subject location 220 for an individual that was determined to be detail subject 218. Additionally, image processing module 210 may determine the detail subject location 220 within field of view 204 (and/or the one or more fields of view 216). The detail subject location may correspond to one or more photoreceptors of image sensor 124. Further, image processing module 210 may utilize the detail subject location 220 to determine a bounding frame 222 for the detail subject 218. The bounding frame 222 may be an area that encloses, encompasses, comprises, is centered on, and/or otherwise includes at least a portion of detail subject 218. Image processing module 210 and/or a processor associated with image processing module 210 may utilize detail subject location 220 to determine bounding frame 222 to indicate a portion of the field of view 204 (and/or the one or more fields of view 216) that contains the detail subject 218.

In various embodiments, image processing module 210 and/or a processor associated with image processing module 210 may determine bounding frame 222 based at least on detail subject location 220. In particular, bounding frame 222 may be a portion of field of view 204 (and/or the one or more fields of view 216)that includes detail subject 218. Additionally, bounding frame 222 may be determined based at least on a recording resolution of the set of images being generated by image processing module 210. Bounding frame 222 may be determined as a portion of field of view 204 (and/or the one or more fields of view 216) that identifies of a portion of the sensor resolution captured by image sensor 124 that equals the recording resolution of image processing module 210. Alternatively, or in addition, bounding frame 222 may be determined as a portion of field of view 204 (and/or the one or more fields of view 216) that identifies a portion of the sensor resolution captured by image sensor 124 that equals an input resolution for image processing module 210.

In various embodiments, image processing module 210 may determine bounding frame 222 to cause capture of detail frame 224. In particular, bounding frame 222 may be determined such that a portion of the image data captured by image sensor 124 is provided to image processing module 210 via a second image processing pipeline. For example, image sensor 124 may capture image data at a sensor resolution that is 4k resolution (e.g., horizontal dimension 206 is equal to 3840 pixels and vertical dimension 208 is equal to 2160). A first image processing pipeline may reduce from the sensor resolution (4k resolution) to a recording resolution that is 1080p resolution (e.g., 1920 pixels by 1080 pixels) in addition to other image processing steps. Bounding frame 222 may be determined by and/or for image processing pipeline to include detail subject 218 such that a horizontal bounding dimension 226 is equal to 1920 pixels and a vertical bounding dimension is equal to 1080 pixels. As a result, and based at least on a determination that detail frame 224 is able to be captured, image sensor 124 may capture image data associated with bounding frame 222 and provide bounding frame image data to a second image processing pipeline of image processing module 210. Accordingly, image processing pipeline 210 may utilize bounding frame image data from bounding frame 222 to record detail frame 224 independent of the step reducing image data from the sensor resolution to the recording resolution. Further, and based at least on horizontal bounding dimension 226 and vertical bounding dimension 228 being equal to the recording resolution, detail frame 224 may be generated and/or recorded without reconfiguring image processing module 210. It should be noted that reconfiguring image processing module 210 may cause a gap in image data recorded as the set of images. Accordingly, providing image data from bounding frame 222 to image processing module 210 may enable the set of images to be generated, including detail frame 224, while minimizing modifications to processing settings for image processing module 210.

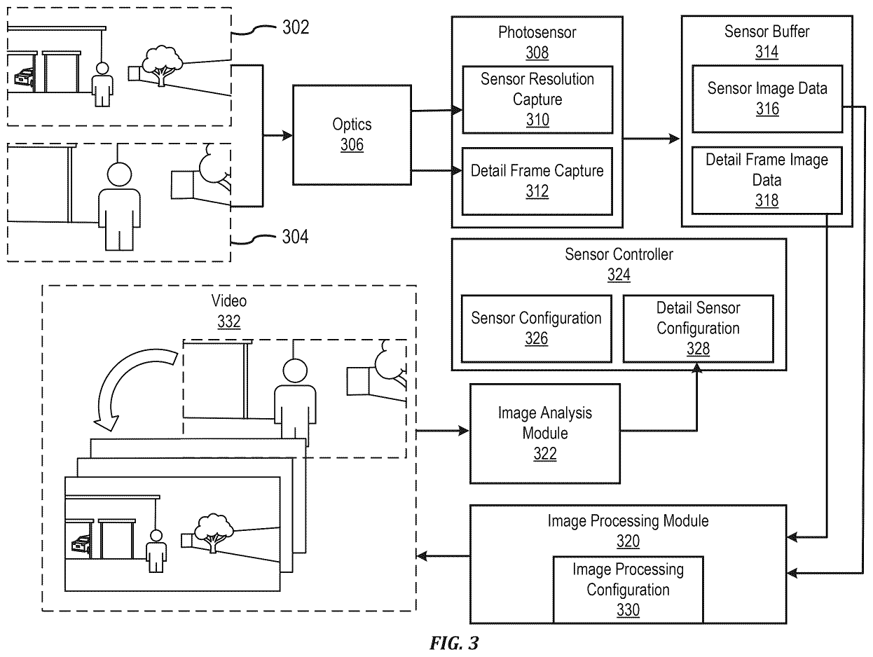

In various embodiments, and with reference to FIG. 3, a recording device for capturing a detail frame is described. In particular, the recording device depicted by FIG. 3 may represent recording device 110, other recording devices and/or other computing devices utilized as a recording system. As previously noted, recording device 110 may be configured to capture a visual point of view at least partially aligned with a point of view of the incident responder. Alternatively, or in addition, the recording device may be configured to capture a visual point of view unassociated with the point of view of the incident responder (e.g., mounted to a vehicle associated with the incident responder).

In various embodiments, a recording device may be configured to capture optical information 302 associated with an incident. In particular, optical information 302 may be captured by, received via, and/or otherwise directed to photosensor 308 by optics 306. Optical information 302 received via optics 306 and captured by a plurality of photoreceptors that comprise photosensor 308. Optical information 302 may be captured at a sensor resolution (e.g., a first resolution, a capture resolution, etc.) by sensor resolution capture 310. Capture of optical information 302 (e.g., via sensor resolution capture 310) may be managed, caused, controlled, and/or otherwise operated by sensor controller 324. Sensor resolution capture 310 may comprise and/or be associated with sensor configuration 326 of photosensor 308, a data buffer setting associated with a sensor buffer, and/or other process for taking digital and/or analog signals output by photoreceptors of photosensor 308 and storing the digital and/or analog signals as optical information 302. As a result, optical information 302 may be captured by photosensor 308 and stored in sensor buffer 314 as sensor image data 316.

In various embodiments, a recording device may be configured to capture optical information 304 for a detail frame. The optical information 304 may be associated with an incident and may be captured in response to a determination that a detail frame is to be generated. In particular, optical information 304 may be captured by, received via, and/or otherwise directed to photosensor 308 by optics 306. Optical information 304 may be received via optics 306 and captured by a set of photoreceptors that comprise photosensor 308. The set of photoreceptors utilized to capture optical information 304 may be determined based at least on a bounding frame (e.g., bounding frame 222). Optical information 304 may be captured at the sensor resolution by detail frame capture 312. Alternatively, or in addition, optical information 304 may be captured at an additional sensor resolution by detail frame capture 312. Capture of optical information 304 (e.g., via sensor resolution capture 310) may be managed, caused, controlled, and/or otherwise operated by sensor controller 324. Detail frame capture 312 may comprise and/or be associated with detail sensor configuration 328 of photosensor 308, a data buffer setting associated with sensor buffer 314, and/or other process for taking digital and/or analog signals output by the set of photoreceptors of photosensor 308 and storing the digital and/or analog signals as detail frame image data 316. As a result, optical information 304 may be captured by photosensor 308 and stored in sensor buffer 314 as detail frame image data 316.

In various embodiments, sensor image data 316 may be utilized to generate a set of images (e.g., an individual image, a plurality of images, etc.) and/or video 332. In particular, image processing module 320 may receive sensor image data 316 at an input resolution associated with image processing module 320 and generate video 332 (or the set of images). Additionally, video 332 (or the set of images) may be generated by image processing module 320 based at least on image processing configuration 330. Sensor image data 316 may be provided to image processing module 320 based at least on an instruction from sensor controller 324. Sensor image data 316 may be directed to image processing module 320 by sensor controller 324. Sensor image data 316 may be received at image processing module 320 from sensor buffer 314. Sensor image data 316 may be obtained by image processing module 320 from sensor buffer 314.

In various embodiments, detail frame image data 318 may be utilized to generate a detail frame. Detail frame may be included in video 332 in place of an image frame that would have been captured at a timestamp where the detail frame was captured. In particular, image processing module 320 may receive detail frame image data 318 at the input resolution associated with image processing module 320 and generate the detail frame. Additionally, the detail frame may be generated by image processing module 320 based at least on image processing configuration 330. Detail frame image data 318 may be provided to image processing module 320 based at least on an instruction from sensor controller 324. Detail frame image data 318 may be directed to image processing module 320 by sensor controller 324. Detail frame image data 318 may be received at image processing module 320 from sensor buffer 314. Detail frame image data 318 may be obtained by image processing module 320 from sensor buffer 314.

In various embodiments, the recording device may determine to capture optical information 302 and/or optical information 304 based at least on a determination that a detail frame is to be captured. Optical information 302 may be captured for video capture, image capture, a standard operating mode for the recording device, a pre-buffer mode of the recording device, and/or other capture of an incident scene. Optical information 304 may be captured for detail frame capture. Detail frame capture may enable a “zoom-in” and/or detailed view of a portion of the incident scene to be captured by the recording device. Optical information 304 may be captured utilizing a subset of the plurality of photoreceptor that comprise photosensor 308. Alternatively, or in addition, optical information 304 may be cropped, extracted, filtered, and/or otherwise obtained from optical information 302. For example, optical information 302 may be captured to generate video 332. During capture of optical information 302, an input may indicate that a detail frame is to be captured. Additionally, and based on the input, sensor controller 324 may utilize detail sensor configuration 328 to cause optical information 304 to be obtained from at least a portion of optical information 302 (e.g., optical information 302 is captured by photosensor 308 and the optical information 304 is selectively obtained based at least on detail sensor configuration 328). Independent of whether sensor resolution capture 310 and/or detail frame capture 312 is utilized to obtain optical information 304, optical information 304 may be obtained by photosensor 308 based at least on detail sensor configuration 328 (e.g., detail sensor configuration 328 is generated based at least on a bounding frame that defines the subset of photoreceptors utilized to capture optical information 304 and/or defines optical information 304 from a portion of optical information 302). Optical information 304 may be stored in sensor buffer 314 by obtaining optical information 304 from optical information 302 based at least on detail frame capture 312 and/or a bounding frame.

In various embodiments, sensor image data 316 may be provided to image processing module 320. In particular, sensor image data 316 may be output by photosensor 308 at an input resolution of image processing module 320. Alternatively, or in addition, an additional module may be operated by sensor controller 324 to modify sensor image data 316 from the sensor resolution to the input resolution prior to provision of sensor image data 316 to image processing module 320. During video capture and/or optical information capture, image processing module 320 may convert optical information (e.g., sensor image data 316, detail frame image data 318) into a video 332 of an incident scene based at least on image processing configuration 330. Additionally, and during video capture, image processing module 320 may be configured to continuously, periodically, and/or otherwise process optical information captured by photosensor 308 to generate the video 332 and/or a set of images associated with the incident scene. Further, and during video capture, image processing configuration 330 of image processing module 320 may include an indication of the input resolution for image processing module 320.

In various embodiments, detail frame image data 318 may be provided to image processing module 320. In particular, capture of a detail frame by recording device may comprise capturing an image that has increased pixel density with reduced field of view. The increased pixel density may be achieved by capturing detail frame image data 318 from within a bounding frame (e.g., bounding frame 222) such that detail frame image data 318 is captured at the input resolution for image signal processing pipeline 324. The bounding frame may be determined based at least on image analysis module 322. As a result, detail frame image data 318 may be provided from sensor buffer 314 to image processing module 320. For example, and during video capture, image processing module 320 may receive sensor image data 316, after sensor image data 316 has been modified from the sensor resolution to the input resolution, to generate a video 332. Additionally, and during video capture, photosensor 308 may capture optical information 304 such that detail frame image data 318 is stored by sensor buffer 314. Further, and during video capture, detail frame image data 318 may be provided from sensor buffer 314 to image processing module 320, wherein the image processing module 320 utilizes image processing configuration 330 for sensor image data 316 and detail frame image data 318. As a result, the video 332 generated by image processing module 320 may contain a set of images generated from sensor image data 316 and a detail frame of a detail subject generated from detail frame image data 318. The set of images generated from sensor resolution image data 316 may have a first field of view that comprises the field of view of photosensor 308. The detail frame of the detail subject may have a second field of view that comprises a portion of the field of view of photosensor 308. The second field of view may provide a “zoomed in” and/or “cropped” view of the detail subject when compared to the first field of view.

In various embodiments, sensor controller 324 may be configured to cause photosensor 308 to capture optical information 302. Sensor controller 324 may determine sensor configuration 326 for capture of optical information 302 by photosensor 308. Sensor controller 324 may determine sensor configuration 326 for output of sensor image data 316 by photosensor 308 and/or buffering of sensor image data 316 within sensor buffer 314. In particular, sensor configuration 326 may be determined by sensor controller 324 to determine the sensor resolution for capture of optical information 302, a binning mode for photosensor 308 during capture of optical information 302, and/or other configuration indication(s) for capture of optical information 302 and storage of sensor image data 316 within sensor buffer 314. As a result, sensor resolution capture 310 may utilize sensor configuration 326 to obtain optical information 302 and provide sensor image data 316.

In various embodiments, sensor controller 324 may be configured to cause photosensor 308 to capture optical information 304. Sensor controller 324 may determine detail sensor configuration 328 for capture of optical information 304 by photosensor 308. Sensor controller 324 may determine detail sensor configuration 328 for output of detail frame image data 318 within sensor buffer 314. In particular, detail sensor configuration 328 may be determined by sensor controller 324 to determine an additional sensor resolution for capture of optical information 304, an additional binning mode for photosensor 308 during capture of optical information 304, offset parameters for a subset of photoreceptors of photosensor 308 during capture of optical information 304, photoreceptor selection parameters (e.g., crop parameters) for the subset of photoreceptors of photosensor 308 during capture of optical information 304, and/or other configuration indication(s) for capture of optical information 304 and storage of detail frame image data 318 within sensor buffer 314. As a result, detail frame capture 312 may utilize detail sensor configuration 328 to obtain optical information 304 and provide detail frame image data 318.

In various embodiments, sensor controller 324 may utilize sensor configuration 326 and detail sensor configuration 326 to cause photosensor 308 to capture optical information 302 and optical information 304. In particular, and during video capture (or capture of a set of images), sensor controller 324 may utilize sensor configuration 326 to cause photosensor 308 to capture optical information 302 and provide sensor image data 316 to sensor buffer 314. For example, sensor configuration 326 may be a default configuration for photosensor 308 during video capture. Additionally, and during video capture, an indication may cause sensor controller 324 to provide detail sensor configuration 326 to photosensor 308. Providing detail sensor configuration 326 to photosensor 308 may cause photosensor 308 to capture optical information 302 and provide detail frame image data 318 to sensor buffer 314.

In various embodiments, sensor controller 324 may determine detail sensor configuration 326 based at least on image analysis module 322. In particular, image analysis module 322 may provide one or more position indications associated with one or more detail subjects to sensor controller 324. Sensor controller 324 may utilize the one or more position indications to determine detail sensor configuration 326. For example, the one or more position indications may be utilized to determine offset parameter(s) and/or photoreceptor selection parameter(s) for capture of optical information 304 and/or providing detail frame image data 318. Offset parameter(s) may be determined such that at least a detail subject is captured by detail frame image data 318. Additionally, photoreceptor selection parameter(s) may be determined such that at least a detail subject is captured by detail frame image data 318. Generally, sensor controller 324 may utilize the one or more position indications associated with the one or more detail subjects to determine detail sensor configuration 326 such that detail frame image data 318 includes the one or more detail subjects.

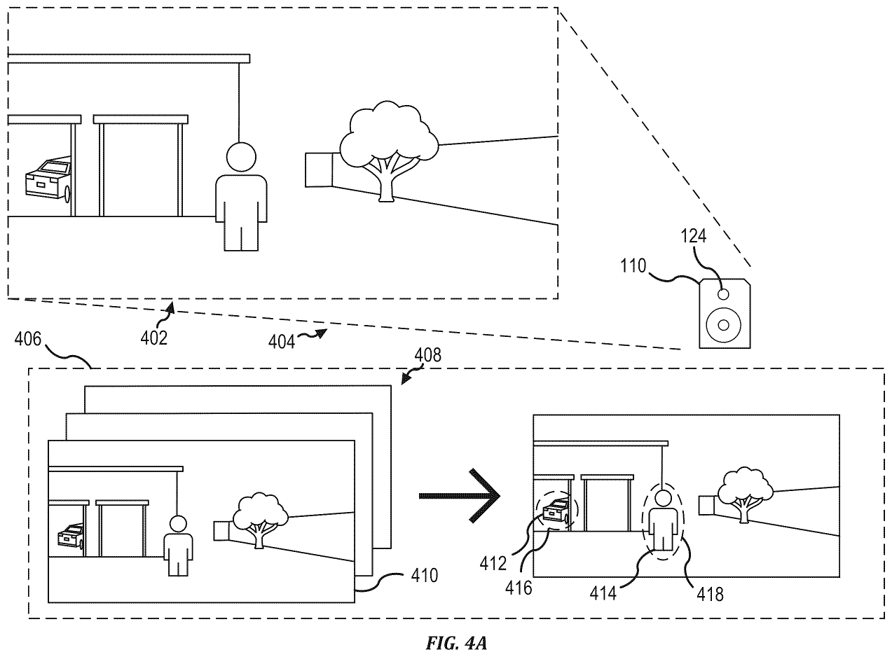

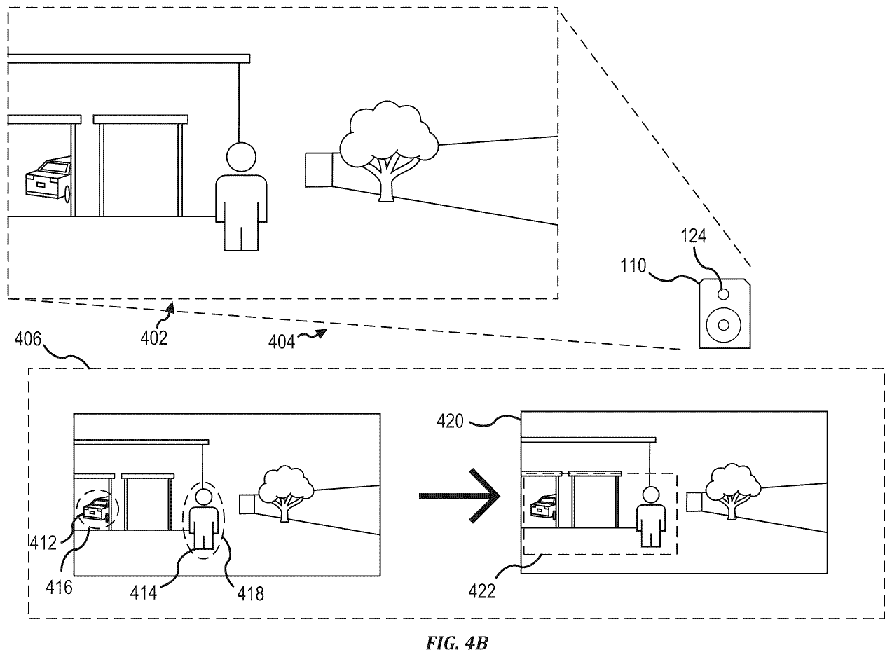

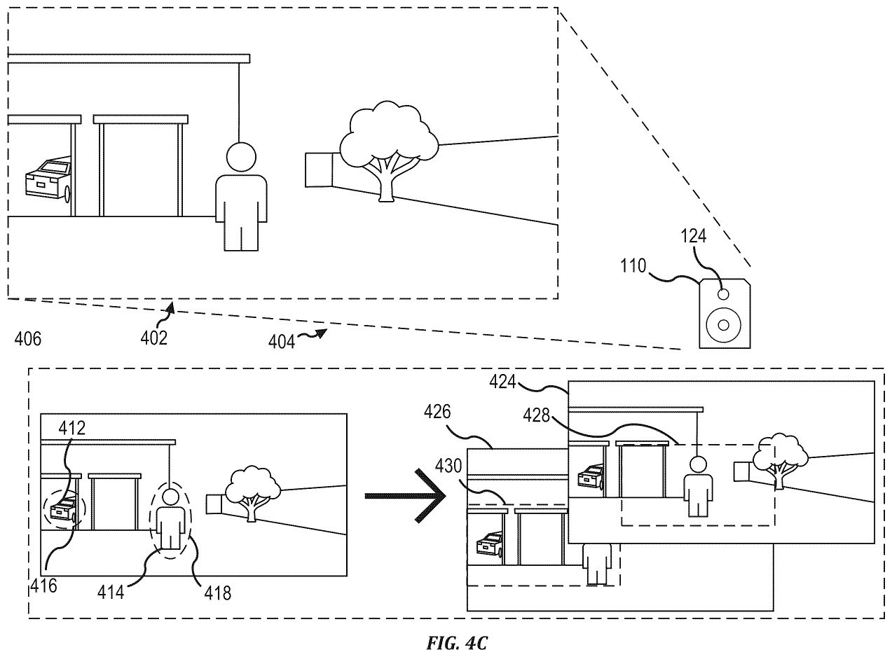

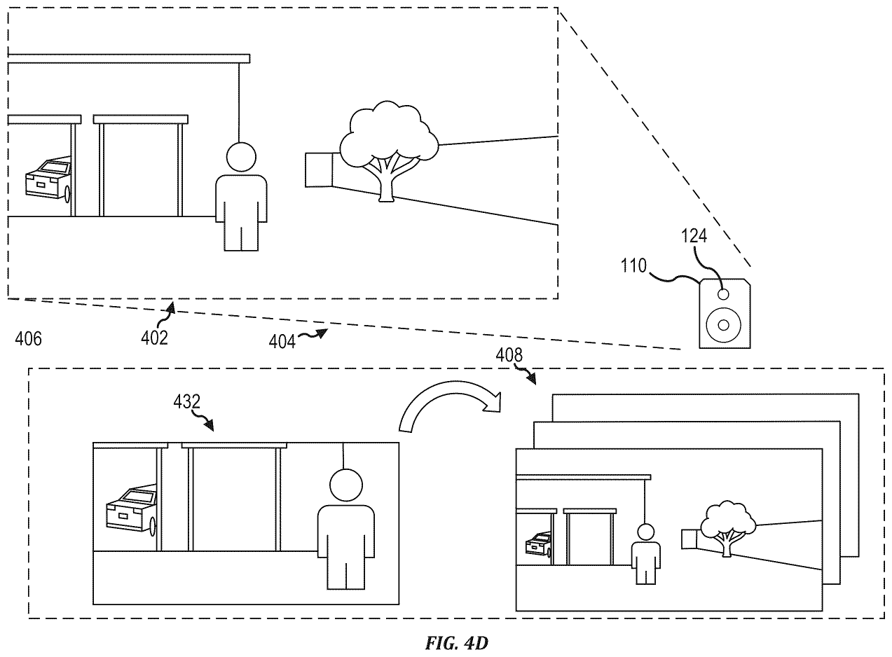

In various embodiments, and with reference to FIG. 4A, recording device 110 may comprise image sensor 124 for capturing an incident scene 402. In particular, recording device 110 may be mounted to an incident responder, a responder vehicle, and/or other mounting point such that image sensor 124 is able to capture optical information of incident scene 402. Image sensor 124 may be associated with a field of view 404 that enables image sensor 124 to collect, obtain, gather, and/or otherwise receive optical information of incident scene 402. Additionally, image sensor 124 may be continuously exposed to optical information from field of view 404. In response, image sensor 124 may be activated by recording device 110 and store optical information as image data within a sensor buffer (e.g., sensor buffer 130). Alternatively, or in addition, image sensor 124 may be selectively exposed to optical information from field of view 404 (e.g., via a shutter system). Independent of exposure to optical information from incident scene 402, image sensor 124 may capture optical information as image data on a periodic, aperiodic, triggered (e.g., by user input, by external signal, by internal determination, etc.), and/or other basis. Further, the image data captured from the optical information may correspond to a single image (e.g., a picture) and/or a plurality of images (e.g., a video).

In various embodiments, recording device 110 may capture optical information via image sensor 124. Image sensor 124 may capture optical information from a field of view 404 of incident scene 402. An image processing module 406 may generate a set of images 408 during video capture. Image sensor 124 may capture optical information at a sensor resolution that is converted to a recording resolution associated with image processing module 406 and the set of images 408. In some embodiments, recording device 110 may be configured to perform operations described above, with reference to FIGS. 2A-2D. Similarly, recording device may be configured to perform operations described above with reference to FIG. 3.

In various embodiments, recording device 110 may be configured to analyze the set of images 410 and determine whether the set of images 410 contains one or more objects of interest. For example, and as depicted by FIG. 4A, the set of images may capture, depict, represent, display, and/or otherwise comprise a first object of interest 412 and a second object of interest 414. Additionally, the first object of interest 412 may have a first location 416 within at least one of field of view 404 and the set of images 410. Similarly, the second object of interest 414 may have a second location 418 within at least one of field of view 404 and the set of images 410. In some embodiments, recording device 110 may determine first location 416 and second location 418 based at least on field of view 404, image sensor 124, and/or the set of images 410.

In various embodiments, image processing module 406 may be configured to determine first location 416 and second location 418. Alternatively, or in addition, an internal component of recording device 110 may be configured to determine first location 416 and second location 418. In particular, an object detection module may be associated with recording device 110 (e.g., as a process performed by image processing module 406, an independent module of recording device 110, etc.). Additionally, the object detection module may determine whether the set of images 410 comprise one or more objects of interest (e.g., first object of interest 412, second object of interest 414, additional object of interest, etc.). Further, the object detection module may determine, for an object of interest determined from the set of images 410, a location of the object of interest within the set of images 410 as a whole and/or individual images of the set of images 410.

In various embodiments, recording device 110 may determine that the set of images 410 contains first object of interest 412 and second object of interest 414. As previously noted, image processing module 410 and/or an object detection module may be associated with a machine learning algorithm, an AI model, computer vision processes, neural networks, a rule set, and/or other analytic processes for identifying one or more objects of interest included in the set of images 410.

In various embodiments, recording device 110 may determine that the set of images 410 contains a plurality of objects of interest (e.g., first object of interest 412, second object of interest 414, etc.). In particular, recording device 110 may be configured to capture one or more detail frames associated with the plurality of objects of interest. In some embodiments, and as depicted by FIG. 4B, a field of view 420 may be utilized to determine a unified bounding frame 422 for first object of interest 412 and second object of interest 414. In some additional embodiments, and as depicted by FIG. 4C, a first field of view 424 may be utilized to determine a first bounding frame 428 for first object of interest 412 and a second field of view 426 may be utilized to determine a second bounding frame 430 for second object of interest 414.

In various embodiments, and as depicted by FIG. 4B, image processing module 406 may determine a unified bounding frame for first object of interest 412 and second object of interest 414. In particular, image processing module 406 and/or a processor associated with recording device 110, may be configured to capture multiple objects of interest in bounding frame 422. For example, image processing module 406 (or a processor of recording device 110) may determine that first location 416 of first object of interest 412 and second location 418 of second object of interest 414 fit within dimensions of a unified bounding frame 422. Image processing module 406 (or an associated processor) may determine that first location 416 and second location 418 are within a threshold distance of each other. Alternatively, or in addition, image processing module 406 (or an associated processor) may determine that first object of interest 412 and second object of interest 414 can be encompassed by unified bounding frame 422, when overlaid onto field of view 420, having dimension equal to a recording resolution associated with the set of images 410.

In various embodiments, and as depicted by FIG. 4B, image processing module 406 may determine unified bounding frame 222 to capture first object of interest 412 and second object of interest 414 in a detail frame. In particular, image processing module 406 (or an associated processor) may determine that unified bounding frame 222 is to be utilized for increased efficiency of image capture and/or to minimize interruption for a video comprising the set of images 410. Alternatively, or in addition, image processing module 406 (or an associated processor) may determine that unified bounding frame 222 is to be utilized based at least on proximity of first location 416 and second location 418. Additionally, image processing module 406 (or an associated processor) may determine whether unified bounding frame 222 fully encompasses first object of interest 412 and second object of interest 414. Further, image processing module 406 (or an associated processor) may determine that unified bounding frame 222 is to be utilized based at least on image activity determined for set of images 410. For example, image processing module 406 may determine that one or more objects within the set of images 410 are moving (e.g., moving relative to field of view 404, moving relative to other objects in the set of images 410, etc.) between individual images. Alternatively, or in addition, image processing module 406 may determine that new objects are entering and exiting field of view 404 between individual images of the set of images 410. Where movement of the one or more objects is greater than a threshold amount and/or presence of new objects is greater than a threshold amount, image processing module 406 (or an associated processor) may utilize the unified bounding frame 222 to minimize detail frames during a high activity period of video capture.

In various embodiments, and as depicted by FIG. 4C, image processing module 406 may determine separate bounding frames for first object of interest 412 and second object of interest 414. In particular, image processing module 406 and/or a processor associated with recording device 110, may be configured to capture individual objects of interest in first bounding frame 428 and second bounding frame. It should be noted, and is depicted in FIG. 4C that proximity of first object of interest 412 and second object of interest 414 may cause first bounding frame 428 and/or second bounding frame 430 to capture object(s) of interest that are not a primary focus. For example, image processing module 406 (or a processor of recording device 110) may determine that first location 416 of first object of interest 412 and second location 418 of second object of interest 414. Image processing module 406 (or an associated processor) may determine first bounding frame 428 to encompass first object of interest 412 at first location 416. Similarly, image processing module 406 (or an associated processor) may determine second bounding frame to encompass second object of interest 414 at second location 416.

In various embodiments, and as depicted by FIG. 4C, image processing module 406 may determine first bounding frame 428 to capture first object of interest 412 in a first detail frame and second bounding frame 340 to capture second object of interest 414 in a second detail frame. In particular, image processing module 406 (or an associated processor) may determine that separate bounding frames are to be utilized for multiple objects of interest for improved capture and/or clarify of objects of interest. Alternatively, or in addition, image processing module 406 (or an associated processor) may determine that separate bounding frames are to be utilized based at least on a distance between first location 416 and second location 418 being greater than a threshold distance.

In various embodiments, image processing module 406 may utilize the set of images 410 to determine first location 416 and second location 418. In particular, object(s) of interest may be mobile within field of view 404 such that a position of the object(s) of interest differs from image to image for the set of images 410. As a result, capturing a detail frame may utilize the set of images 410 to determine location(s) for the object(s) of interest. For example, image processing module 406 may utilize the set of images 410 to determine first location 416, wherein first location 416 is a predicted position of the first object of interest 412. First location 416 may be representative a position of first object of interest 412 in field of view 404 for capture of a detail frame associated with first object of interest 412. Field of view 420 and/or first field of view 424 may represent the determination of first location 416 for capture of the detail frame associated with first object of interest 412. Similarly, image processing module 406 may utilize the set of images 410 to determine second location 418 and/or one or more additional locations, wherein second location 418 is a predicted position of the second object of interest 414 and/or one or more additional objects of interest. The second location may be representative of a position of second object of interest 414 in field of view 404 for capture of a detail frame associated with second object of interest 414. Field of view 420 and/or second field of view 426 may represent the determination of second location 418 for capture of the detail frame associated with second object of interest 414.

In various embodiments, first location 416 may be utilized to determine unified bounding frame 422 and/or first bounding frame 428 for first object of interest 412. As noted above, first location 416 may be associated with a predicted position of first object of interest 412 in field of view 404 at a first time when a first detail frame is captured for first object of interest 412. It should be noted that field of view 420 and/or first field of view 424 may be representations of first location 416. For example, first location 416 may comprise coordinates for first object of interest 412, a border of first object of interest 412, and/or other representation of where first object of interest 412 is and/or will be within field of view 404. As a result, first location 416 may be utilized to determine unified bounding frame 422 and/or first bounding frame 428 such that use of image data from unified bounding frame 422 and/or first bounding frame 428 captures first object of interest 412.

In various embodiments, second location 418 may be utilized to determine unified bounding frame 422 and/or second bounding frame 430 for second object of interest 414. As noted above, second location 418 may be associated with a predicted position of second object of interest 414 in field of view 404 at a first time when a first detail frame is captured for second object of interest 414. It should be noted that field of view 420 and/or second field of view 426 may be representations of second location 418. For example, second location 418 may comprise coordinates for second object of interest 414, a border of second object of interest 414, and/or other representation of where second object of interest 414 is and/or will be within field of view 404. As a result, second location 418 may be utilized to determine unified bounding frame 422 and/or second bounding frame 430 such that use of image data from unified bounding frame 422 and/or second bounding frame 430 captures second object of interest 414.

In various embodiments, and as depicted by FIG. 4D, image sensor 124 may capture a detail frame 432. In particular, and based at least on a bounding frame, image sensor 124 may capture a detail frame. For example, image sensor 124 may capture a first detail frame and a second detail frame based at least on first bounding frame 428 and second bounding frame 430. Alternatively, or in addition, image sensor 124 may capture a unified detail frame 432 based at least on unified bounding frame 422. Detail frame 432 may capture first object of interest 412 and/or second object of interest 414 based at least on one of: unified bounding frame 422, first bounding frame 428, and/or second bounding frame 430. Detail frame 432 may be captured via optical information recorded by image sensor 124 that is associated with at least one of: unified bounding frame 422, first bounding frame 428, and/or second bounding frame 430.

In various embodiments, detail frame 432 may be recorded during video capture. In particular, the set of images 410 may be recorded by recording device 110 as part of a video capture operation, wherein the set of images 410 may be individual frames of a video. Optical information may be captured by image sensor 124 and processed by image processing module 406 to generate the set of images 410. During video capture, an object detection module may determine that the set of images 410 include first object of interest 412 and/or second object of interest 414. Additionally, image processing module 406 (or an associated processor) may determine that at least one of unified bounding frame 422, first bounding frame 428, and/or second bounding frame 430 are to be recorded during video capture. Further, a processor associated with image sensor 124 may cause optical information from at least one of unified bounding frame 422, first bounding frame 428, and/or second bounding frame 430 to be provided to image processing module 406 to produce a detail frame with increased pixel density and reduced field of view in comparison to the set of images 410. Detail frame 432 may be insert into the set of images 410 in place of a corresponding image such that the video generated includes the detail frame in sequence with the set of images 410.

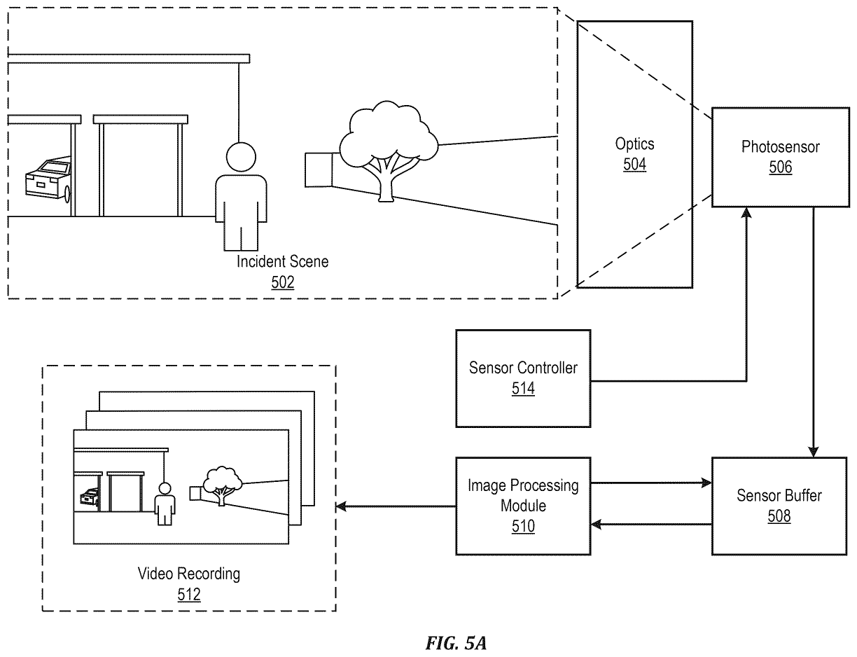

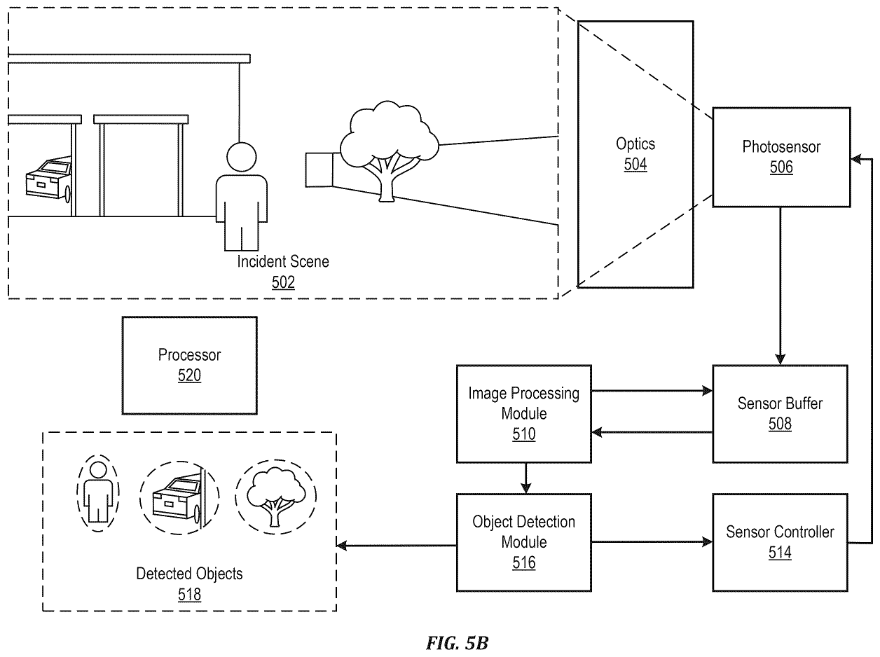

In various embodiments, and with reference to FIGS. 5A and 5B, recording device 500 (e.g., recording device 110) may receive optical information of an incident scene 502 via optics 504 and photosensor 506 (e.g., image sensor 124). Recording device 500 may be mounted to an incident responder, a responder vehicle, and/or other mounting point. Photosensor 506 may be associated with a field of view from which photosensor 506 collects, obtains, gathers, and/or otherwise receives optical information of incident scene 502. Recording device 500 may be configured to perform various operations described above and comprise various components described above.

In various embodiments, recording device 500 may be configured to perform video capture operations to generate video of incident scene 502. During video capture, optical information may be directed from incident scene 502 onto photosensor 506 by optics 504. Photosensor 506 may receive optical information from incident scene 502 and periodically convert the optical information into image data. Conversion of optical information into image data may occur periodically based at least on a frame rate of the video, a shutter rate of optics 504, a capture rate of photosensor 506, and/or other mechanism for generating individual images of the video.

In various embodiments, image data generated by photosensor 506 may be provided to and stored via sensor buffer 508. In particular, photosensor 506 may provide portions of image data that will be converted into individual images of video recording 512. For example, photosensor 506 may be configured to capture and/or record individual portions of image data that are arranged in chronological order, timestamped based on when they were captured, and/or otherwise sequenced. Photosensor 506 may provide the individual portions of image data to sensor buffer 508 as ordered image data, timestamped image data, identified image data, and/or otherwise sequenced image data. Image processing module 510 may obtain image data from sensor buffer 508 and generate the set of images for video recording 512. Additionally, image processing module 510 may generate individual images of video recording 512 in sequence based at least on portions of the image data captured by photo sensor 506. Further, the sequence of the individual images of video recording 512 may be determined based at least on metadata, timestamps, order indications, and/or other information associated with portions of the image data.

In various embodiments, and as depicted by FIG. 5B, photosensor 506, sensor buffer 508, and/or image processing module 510 may be associated with sensor controller 514. In particular, sensor controller 514 may be a central processor of recording device 500. Alternatively, or in addition, sensor controller 514 may be operated by processor 520, wherein processor 520 transmits instructions and/or requests to sensor controller 514. Independent of the relationship between sensor controller 514 and processor 520, sensor controller 514 may cause a detail frame to be captured from incident scene 502. In particular, sensor controller 514 may receive an input indicating that the detail frame is to be captured. Alternatively, or in addition, sensor controller 514 may determine that the detail frame is to be captured.

In various embodiments, sensor controller 514 may cause a detail frame to be captured from incident scene 502. In particular, processor 520 may receive an input that indicates the detail frame is to be captured. The input may be a user input that is received via a user interface. Alternatively, or in addition, the input may be a remote input that is received from a server, a cloud platform, a remote user device, and/or other remote source. The input received by processor 520 may be configured to trigger capture of the detail frame via sensor controller 514. Alternatively, or in addition, the input received by processor 520 may request capture of the detail frame at a capture opportunity. It should be noted that a capture opportunity may be determined based at least on object activity in video recording 512, movement of recording device 500 (e.g., determined by geolocation, inertia measurements, etc.), accessory device state (e.g., CEW drawn, CEW holstered, weapon drawn, weapon holstered, etc.), assignment state associated with recording device 500, and/or other activity indicator associated with recording device 500. For example, a capture opportunity may be determined based at least on object activity in video recording 512 being less than a threshold activity value. For example, a capture opportunity may be determined based at least on a determination that recording device 500 is not moving and/or is moving less than a threshold movement value. For example, a capture opportunity may be determined based at least on one approved accessory device states for detail frame capture. For example, a capture opportunity may be determined based at least on the assignment state of the recording device 500 being assigned to an incident, being involved in an ongoing incident, responding to an incident, and/or other indication that recording device 500 is associated with an incident. For example, a capture opportunity may be determined based at least on the assignment state of the recording device 500 being available and/or unassigned, is unassociated with an incident, and/or other indication that recording device 500 is available to capture a detail frame. Generally, a capture opportunity may be determined based at least on one or more indications that recording device 500 is not involved in a situation where loss of field of view would negatively impact incident information capture. Alternatively, or in addition, a capture opportunity may be determined based at least on an accuracy of a bounding frame and/or object of interest location (e.g., if field of view is rapidly changing, perspectives are shifting, and/or otherwise has a high level of activity, it may be difficult to determine the bounding frame for capturing the detail frame).

In various embodiments, processor 520 and/or image processing module 510 may be associated with object detection module 516. As noted above, sensor controller 514 may cause object detection module 516 to analyze at least a portion of video recording 512 to determine one or more detected objects 518. Object detection module 516 may utilize various computer vision algorithms and/or other object detection algorithms (e.g., machine learning algorithm(s), AI algorithms, etc.) to determine one or more detected objects 518 from image data captured by photosensor 506 and/or video recording 512. Additionally, sensor controller 514 and object detection module 516 may enable determination of one or more detected objects 518 and one or more objects of interest from the one or more detected objects 518.

In various embodiments, processor 520 may be configured to determine whether a detail frame is able to be captured from incident scene 502. In particular, processor 520 may receive an input that indicates the detail frame is to be captured at a capture opportunity. The input may be a user input that is received via a user interface. Alternatively, or in addition, the input may be a remote input that is received from a server, a cloud platform, a remote user device, and/or other remote source. The capture opportunity may be determined based at least on monitoring incident scene 502 for an object of interest. The capture opportunity may be determined based at least on one or more detected objects 518. For example, a capture opportunity may be determined based at least on a detected object of the one or more detected objects 518 being identified as an object of interest. Processor 520 may cause object detection module 516 to detect one or more detected objects 518 from video recording 512 and/or determine whether one or more detected objects 518 are one or more objects of interest. Processor 520 may continuously, periodically, and/or otherwise trigger object detection module 516 to determine whether one or more detected objects 518 include an object of interest. Where processor 520 determines, at a first time that one or more detected objects 518 include an object of interest, the first time may be utilized as a capture opportunity. Where processor 520 determines, at the first time that one or more detected objects 518 do not include an object of interest, the first time may be prevented from utilization as a capture opportunity. Additionally, and at a second time after the first time, processor 520 may determine that one or more detected objects include an object of interest and cause the second time to be utilized as a capture opportunity.

In various embodiments, processor 520 may cause sensor controller 514 to trigger the detail capture of an object of interest via photosensor 506. In particular, processor 520 may determine a capture opportunity for the detail capture and provide an indication to sensor controller 514 to cause detail capture based at least on the capture opportunity. As noted above, video recording 512 may be captured by photosensor 506 utilizing a first sensor configuration generated by sensor controller 514. Additionally, in response to the capture opportunity, sensor controller 514 may generate a second sensor configuration to cause photosensor 506 to capture the detail frame at the capture opportunity. In some embodiments, the capture opportunity may be associated with processor 520 enabling and/or causing sensor controller 514 to capture the detail frame. Alternatively, capture opportunity may be associated with processor 520 confirming that the object of interest and/or details subject is within the field of view of photosensor 506 and may be captured by the detail capture. The capture opportunity may be associated with a duration and/or duration configuration during which the detail capture occurs.

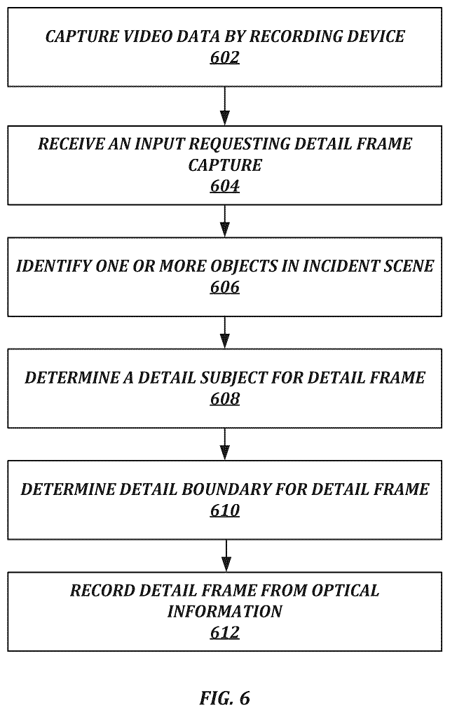

FIG. 6 is a flowchart illustrating a method for capturing a detail frame of an incident scene during video capture, according to some embodiments. For example, and in accordance with various embodiments, the method may include one or more steps for capturing one or more detail frames by a recording device. In embodiments described in conjunction with FIG. 6, the method may be performed by one or more recording devices similar to any recording devices described herein, e.g., the recording device 110 of FIG. 1. In other embodiments, the method may be performed in part or in whole by other entities of a recording system. In other embodiments, the method may comprise additional or fewer steps, and the steps may be performed in a different order than described in conjunction with FIG. 6.

In various embodiments, and at block 602, a recording device may capture video data associated with an image scene. In particular, video data may comprise portions of image data that are captured by an image sensor of the recording device. The recording device may capture one or more portions of image data in a sequence and store the one or more portions of image data in a sensor buffer and/or other memory of the recording device. Additionally, the one or more portions of image data may be utilized by an image processing module and/or an image signal processing pipeline to generate a video recording. Capture of image data may be associated with a first sensor configuration of the image sensor. The first sensor configuration may comprise indications of a first sensor resolution, a binning mode (e.g., binning enabled) to be applied to captured image data, and/or an output resolution for image data.

In various embodiments, and at block 604, a recording device may receive an input requesting detail frame capture. In particular, a request for a detail frame capture may comprise a request for capture of a detail frame having increased pixel density and reduced field of view compared to a video frame capture, a normal frame capture, and/or other standard capture of image data for a video recording. Additionally, the detail frame may have a detail frame resolution equal to a video frame resolution.

In various embodiments, and at block 604, the recording device may receive a user input requesting detail frame capture. In particular, the user input may be received via a user interface of the recording device. Additionally, the user input may cause the recording device to capture a detail frame. For example, the user input may directly trigger capture of the detail frame by initiating the detail frame capture processes independent of determining detail frame capture opportunities. Alternatively, or in additionally, the user input may indirectly trigger capture of the detail frame, wherein indirect triggering of the detail frame capture process comprises determining a detail frame capture opportunity.

In various embodiments, and at block 604, the recording device may receive a remote input requesting detail frame capture. In particular, the remote input may be received from one or more remote sources (e.g., a cloud-based platform associated with the recording device, a server associated with the recording device, a remote user device associated with the recording device, a streaming interface that the recording device is providing streamed vide data to, etc.). The remote input may directly and/or indirectly trigger capture of the detail frame via one or more detail frame processes.

In various embodiments, and at block 604, the recording device may receive an internal input requesting detail frame capture. In particular, the internal input may be received from one or more internal processes, the one or more internal processes configured to determine objects of interest from at least one of image data portions captured by the recording device and/or video data generated by the recording device. Additionally, the internal input may be received based at least on the one or more internal processes determining that an object of interest has entered a field of view of the recording device and is to be captured via detail frame. For example, a first internal process may be configured to capture one or more detail frames of one or more individuals that are recorded by the recording device. The first internal process may operate to determine when an individual enters the field of view of the recording device. The first internal process may operate to determine when the individual becomes an object of interest (e.g., the individual remains in the field of view for a threshold period of time, for a threshold number of frames, within a threshold proximity to the recording device, is associated with captured audio, the recording device receives an indication that the individual is an object of interest, the input received by the recording device indicates that the individual is an object of interest, etc.). In an additional example, a second internal process may be configured to capture one or more detail frames of one or more vehicles that are recorded by the recording device. The second internal process may operate to determine when a vehicle enters the field of view of the recording device. The second internal process may operate to determine when the vehicle becomes an object of interest (e.g., the vehicle remains in the field of view for a threshold period of time, the vehicle remains in the field of view for a threshold number of frames, within a threshold proximity to the recording device, the individual is associated with captured audio, the recording device receives an indication that the individual is an object of interest, the input received by the recording device indicates that the individual is an object of interest, etc.).

In various embodiments, and at block 606, the recording device may identify one or more objects in an incident scene. In particular, the recording device may comprise an object detection module that analyzes one or more portions of image data captured by the recording device and/or video data generated by the recording device. Additionally, the object detection module may be configured to determine one or more objects in video data (and/or image data). The object detection module may be configured to determine one or more objects that are associated with an incident scene and are within the field of view of the recording device. Further, the object detection module may be configured to determine one or more attributes associated with the one or more objects. For example, the object detection module may determine distance between an object and the recording device (e.g., proximity), an object type of the object (e.g., building, vehicle, individual, animal, scenery, flora, fauna, inanimate, etc.), a velocity associated with the object, a perspective of the object (e.g., front view, rear view, side view, etc.), and/or other attributes associated with the object.

In various embodiments, and at block 608, the recording device may determine a detail subject for the detail frame. In particular, the recording device may determine the detail subject for the detail frame based at least on the input indicating that a detail frame is to be captured. In some embodiments, where the input identifies the detail subject, the recording device may determine the detail subject based at least on the identified subject of the input. In some additional embodiments, the recording device may determine the detail subject in response to the input indicating a detail frame is to be captured. The recording device may be associated with a detail subject ruleset, configuration, and/or other attribute identifier indicating one or more objects that are to be utilized as one or more detail subjects. Additionally, the recording device may utilize the detail subject ruleset (and/or other determining factor for identifying the one or more detail subjects) to determine whether the one or more objects determined by the object detection module include one or more detail subjects. For example, the detail subject ruleset may indicate that individuals, vehicles, and residences are to be utilized as the one or more detail subjects. In response to the input, the recording device may determine the one or more detail subjects that are within the field of view of the recording device.

In various embodiments, and at block 608, the recording device may determine whether one or more objects determined by the object detection module are one or more detail subjects. In particular, a detail subject ruleset may include one or more detail subject object types and one or more additional factors for determining the one or more detail subjects. As noted above, the one or more detail subject object types may indicate that one or more object types associated with the one or more objects are to be considered as one or more potential detail subjects. Additionally, the one or more additional factors may be utilized to confirm or reject the one or more potential detail subjects as the one or more detail subjects. For example, the detail subject ruleset may indicate that object(s) having an object type of vehicle and have been in the field of view of the recording device for a threshold duration are to be flagged as detail subject(s). Generally, the one or more additional factors may confirm the one or more potential detail subjects as the one or more detail subjects based at least on a threshold duration in the field of view, a threshold duration in proximity to the recording device, a threshold distance (or proximity) between the potential detail object and the recording device, an object perspective, and/or other attributes associated with the potential detail subject. It should be noted that the detail subject ruleset may be configured locally via a user interface of the recording device. Alternatively, the detail subject ruleset may be configured by a remote device, cloud platform, serve, and/or other device associated with the recording device.

In various embodiments, and at block 610, the recording device may determine a bounding frame for the detail subject. In particular, the recording device may determine a bounding frame that encompasses, surrounds, encloses, and/or other comprises a region of the field of view that includes the detail subject (and/or detail subjects). The bounding frame may be a region that is defined by the recording device within the field of view that includes the detail subject. The bounding frame may be defined such that dimensions of the bounding frame are equal to at least one of a recording resolution of the recording device and/or an input resolution for an image signal processing pipeline of the recording device. As a result of the bounding frame having dimensions that are equal to the recording resolution and/or the input resolution, image data from the bounding frame may be provided to the image processing module and/or image signal processing pipeline of the recording device. Providing image data from the bounding frame to the image processing module and/or image signal processing pipeline may enable generation of the detail frame having increased pixel density and reduced field of view independent of a recalibration and/or reconfiguring operation for the image processing module and/or image signal processing pipeline. Additionally, providing image data from the bounding frame to the image processing module and/or image signal processing pipeline may enable generation of the detail frame independent of and/or while minimizing blank frames, dead frames, duplicate frames, and/or other dummy frames included in video data generated by recording device.

In various embodiments, and at block 610, the recording device may determine a bounding frame for the detail subject within the field of view of the recording device. In particular, the recording device may determine a bounding frame based at least on a position of one or more detail subjects within the field of view of the recording device. Additionally, the recording device may be configured to generate one or more bounding frames for the one or more detail subjects. For example, the recording device may generate a bounding frame for a detail subject in the field of view. For example, the recording device may generate a bounding frame for a first detail subject and a second detail subject based at least on a first position of the first detail subject being within a threshold distance of a second position of the second detail subject such that the bounding frame includes both the first detail subject and the second detail subject. For example, the recording device may generate a first bounding frame for the first detail subject and a second bounding frame for the second detail subject. For example, the recording device may generate a bounding frame for one or more detail subjects, a first bounding frame for a first detail subject of the one or more detail subjects, and a second bounding frame for a second detail subject of the one or more detail subjects. Generally, the recording device may be associated with a configuration that determines how one or more detail frames are generated for the one or more detail subjects, a distance threshold for including multiple detail subjects in a single bounding frame, and/or other factors for determining the one or more bounding frames.

In various embodiments, and at block 610, the recording device may determine a bounding frame for a detail subject based at least on a position of the detail subject. In particular, the position of the detail subject may be a position within the field of view of the recording device. It should be noted that the position of the detail subject within the field of view is associated with an apparent position of the detail subject within a two dimensional plane of the field of view. The position of the detail subject within the field of view may be associated with the location of the detail subject within the incident scene. Generally, the position of the detail subject may be associated with a set of photoreceptors of the recording device that capture optical information from the detail subject as image data. Additionally, the position of the detail subject may be determined from one or more portions of image data previously recorded by the recording device, video data generated by the recording device, one or more images of a video recording generated by the recording device, and/or other optical information previously captured, collected, recorded, and/or received by the recording device. The position of the detail subject may be determined based at least on an image, a frame of a video, and/or other singular instance of image data. Alternatively, or in addition, the position of the detail subject may be determined based at least on a set of images, a set of frames, and/or multiple instances of image data. The position of the detail subject may be determined as an average position (or weighted average position) of the detail subject taken from the set of images, the set of frames, and/or the multiple instances of image data.

In various embodiments, and at block 612, the recording device may record the detail frame from optical information received by the recording device. In particular, recording device may utilize optical information captured from a set of photoreceptors corresponding to the bounding frame in the field of view to generate the detail frame. Alternatively, or in addition, the recording device may crop optical information captured by the image sensor from the field of view such that a portion of the optical information corresponding to the bounding frame is utilized to generate the detail frame. Additionally, the detail frame may be recorded as an individual image and/or inserted into a video recording in place of a normal frame that would be generate at a timestamp of the detail frame. Further, capture of the detail frame may be associated with a second sensor configuration. The second sensor configuration may be determined based at least on the bounding frame in the field of view to cause the optical information from the bounding frame to be captured as detail frame image data and generation of the detail frame. For example, the second sensor configuration may comprise a second capture resolution, one or more offset coordinates (e.g., bounding frame is not centered within the field of view), a binning mode (e.g., binning enabled), a crop setting (e.g., crop optical information to the bounding frame), an output resolution, and/or other sensor settings for capture of the detail frame). The second sensor configuration may be determined based at least on the bounding frame.

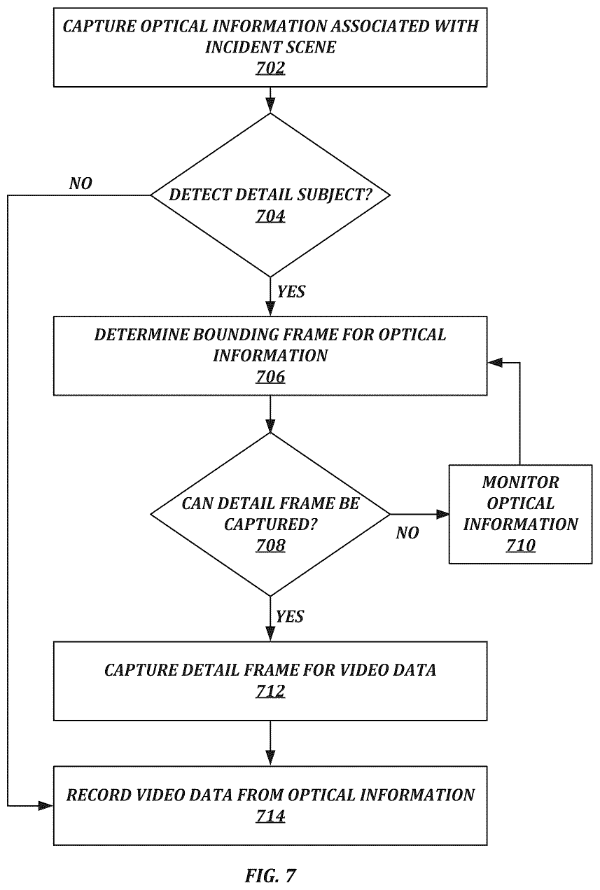

FIG. 7 is a flowchart illustrating a method for capturing a detail frame of an incident scene during video capture, according to some embodiments. For example, and in accordance with various embodiments, the method may include one or more steps for capturing one or more detail frames by a recording device. In embodiments described in conjunction with FIG. 7, the method may be performed by one or more recording devices similar to any recording devices described herein, e.g., the recording device 110 of FIG. 1. In other embodiments, the method may be performed in part or in whole by other entities of a recording system. In other embodiments, the method may comprise additional or fewer steps, and the steps may be performed in a different order than described in conjunction with FIG. 7.

In various embodiments, and at block 702, the recording device may capture optical information from an incident scene. In particular, the recording device may capture optical information and generate a video recording from the optical information.

In various embodiments, and at block 704, the recording device may determine whether a detail subject is within the field of view of the recording device. In particular, the recording device may be configured to analyze the optical information, image data, video data, and/or the video recording (e.g., images of the video recording) to determine whether a detail subject is within the field of view. As noted above, an object detection module may determine one or more objects within the field of view of the recording device. Additionally, the recording device may utilize a detail subject ruleset to determine whether the one or more objects qualify as a detail subject. Further, the recording device may receive an input and/or an indication that identifies a detail subject in the field of view from a remote device (e.g., remote server, cloud platform, remote user device, etc.).

In various embodiments, and at block 704, the recording device may determine whether the field of view includes one or more detail subjects. Where the recording device determines that the field of view includes one or more detail subjects, the process may continue to block 706. Where the recording device determines that the field of view does not include one or more detail subjects, the process may continue to block 714 where optical information is processed to generate video data for a video recording.

In various embodiments, and at block 706 and 708, the recording device may determine a bounding frame for the detail subject and determine whether a detail frame can be captured. As recited above, the recording device may be configured to determine the bounding frame for capturing a detail frame of the object of interest. Additionally, the recording device may be configured to determine whether the detail frame can be captured. In particular, the recording device may be associated with a detail subject ruleset that defines one or more factors for enabling capture of a detail frame for a detail subject. For example, the detail subject ruleset (in addition to enabling determinations that objects are objects of interest/detail subjects) may include an activity threshold, an assignment status, and/or other rule for enabling the detail frame to be captured. For example, the detail subject ruleset may be associated with a maximum activity threshold reduce the likelihood of capturing a detail frame that fails to record the detail subject (e.g., the detail frame missed the detail subject because the detail subject moved outside of the bounding frame). For example, the detail subject ruleset may be associated with an assignment status that enables the capture of detail frames (e.g., assigned to an incident, responding to an incident, etc.). For example, the detail subject ruleset may be associated with an activity indication that enables and/or prevents capture of the detail frame (e.g., a traffic stop may enable capture of a detail frame, an active pursuit scenario may prevent capture of the detail frame to maintain the full field of view during pursuit, etc.). Generally, the detail subject ruleset may be configured to enable or disable detail frame capture via one or more rules implemented via a user interface and/or a remote device associated with the recording device.

In various embodiments, and at blocks 708 and 710, the recording device may determine that the detail frame capture is to be prevented. Additionally, the recording device may monitor optical information, image data, video data, and/or video recordings (e.g., one or more frames of the video recordings) to determine whether detail frame capture is to be re-enabled. In particular, a determination to prevent detail frame capture (e.g., based at least on the detail subject ruleset) may cause recording device to monitor the field of view (e.g., via image data and/or images associated with the field of view) for a capture opportunity for the detail frame. Further, and based at least on a determination that the detail frame can be captured, the recording device may return to block 706 to determine the bounding frame for detail frame capture.

In various embodiments, and at block 712 and 714, the record device may capture optical information for the detail frame from the bounding frame and record the detail frame.

In various embodiments, a computer-based system may be appropriate for use in accordance with various recording device embodiments of the present disclosure. The accompanying description of a computer-based system may be applicable to servers, personal computers, mobile phones, smart phones, tablet computers, embedded computing devices, and other currently available or yet-to-be-developed devices that may be used in accordance with embodiments of the present disclosure.

A computer-based system may include a processor and a system memory connected by a communication bus. Depending on the exact configuration and type of computer-based system, system memory may be volatile or nonvolatile memory, such as read only memory (“ROM”), random access memory (“RAM”), EEPROM, flash memory, or other memory technology. Those of ordinary skill in the art and others will recognize that system memory typically stores data and/or program modules that are immediately accessible to and/or currently being operated on by the processor. In this regard, the processor may serve as a computational center of the computer-based system by supporting the execution of instructions. The processor may comprise one or more processing units, as discussed further herein. The system memory may comprise one or more memory units, as discussed further herein.

A computer-based system may include a network interface comprising one or more components for communicating with other devices and systems over a network. Embodiments of the present disclosure may access basic services that utilize the network interface to perform communications using common network protocols. The network interface may comprise a communications unit, as discussed further herein.

A computer-based system may also include a storage medium. However, services may be accessed using a computer-based system that does not include means for persisting data to a local storage medium. Therefore, the storage medium may be optional. The storage medium may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like. A Storage medium may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data.

A computer-based system may include input devices, such as a keyboard, keypad, mouse, trackball, microphone, video camera, touchpad, touchscreen, electronic pen, stylus, and/or any other input device described herein. Such input devices may be coupled to the computer-based system by wired or wireless connections including RF, infrared, serial, parallel, BLUETOOTH®, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to a computer-based system (e.g., a client device), or can be integral components of a computer-based system. In some embodiments, multiple input devices may be combined into a single, multifunction input device (e.g., a video camera with an integrated microphone).

A computer-based system may also include output devices such as a display, speakers, printer, and/or any other output device described herein. The output devices may include video output devices such as a display or touchscreen. The output devices also may include audio output devices such as external speakers or earphones. The output devices can be separate from and communicatively coupled to the computer-based system, or can be integral components of the computer-based system. Input functionality and output functionality may be integrated into the same input/output device (e.g., a touchscreen). Any suitable input device, output device, or combined input/output device either currently known or developed in the future may be used with described systems.

In various embodiments, a “processing unit” as described herein may comprise any suitable hardware and/or software-based processing component. For example, a processing unit may comprise one or more of a processing circuit, a processor, an application specific integrated circuit (ASIC), a controller, a microcontroller, a microprocessor, a programmable logic device, logic circuitry, and/or the like.

In various embodiments, a “communications unit” as described herein may comprise any suitable hardware and/or software components capable of enabling the transmission and/or reception of data. A communications unit may enable electronic communications between devices and systems. A communications unit may enable communications over a network. Examples of a communications unit may include a modem, a network interface card (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

Two or more of the system components may be in electronic communication via a network. As used herein, the term “network” may further include any cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

Electronic communications between the systems and devices may be unsecure. A network may be unsecure. In other embodiments, and to provide secure communications, electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

The foregoing description discusses preferred embodiments of the present invention, which may be changed or modified without departing from the scope of the present invention as defined in the claims. Examples listed in parentheses may be used in the alternative or in any practical combination. As used in the specification and claims, the words ‘comprising,’ ‘comprises,’ ‘including,’ ‘includes,’ ‘having,’ and ‘has’ introduce an open-ended statement of component structures and/or functions. In the specification and claims, the words ‘a’ and ‘an’ are used as indefinite articles meaning ‘one or more.’ While for the sake of clarity of description, several specific embodiments of the invention have been described, the scope of the invention is intended to be measured by the claims as set forth below. In the claims, the term “provided” is used to identify an object that is not a claimed element of the invention but an object that performs the function of a workpiece that cooperates with the claimed invention. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”. A person of ordinary skill in the art will appreciate that this disclosure includes any practical combination of the structures and methods disclosed. While for the sake of clarity of description several specifics embodiments of the invention have been described, the scope of the invention is intended to be measured by the claims as set forth below. Where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The words “herein,” “hereunder,” “above,” “below,” and other word that refer to a location, whether specific or general, in the specification shall refer to any location in the specification.

What is claimed is:

1. A system for capturing a detail frame for a recording device, the system comprising:
an image sensor of the recording device that operates to:
capture a first amount of image data at a first resolution associated with the image sensor; and
apply a first filter to the first amount of image data, the first filter modifying the first amount of image data from the first resolution to a second resolution;
an image processing module of the recording device that operates to:
receive the first amount of image data from the image sensor at the second resolution;
generate a set of images from the first amount of image data; and
record the set of images at a third resolution; and
an image sensor controller associated with the image sensor, the image sensor controller configured to:
determine that a detail subject within the set of images is to be captured by a detail frame;
determine a detail boundary that includes the detail subject for the detail frame;
provide a second filter to the image sensor, the second filter determined, based at least on the detail boundary, to obtain a subset of a second amount of image data having the second resolution;
cause the image sensor to capture the second amount of image data at the first resolution and apply the second filter to the second amount of image data; and
cause the image sensor to provide the subset of the second amount of image data to the image processing module, at the second resolution, to generate the detail frame.

2. The system of claim 1, wherein:
the first resolution is 3840 pixels by 2160 pixels;
the second resolution is 1920 pixels by 1080 pixels;
the third resolution 1920 pixels by 1080 pixels; and
the detail boundary is determined to have dimensions of 1920 pixels by 1080 pixels.

3. The system of claim 1, wherein:
the first resolution is equal to a sensor resolution at which the first amount of image data and the second amount of image data is captured by the image sensor;
the second resolution is equal to an input resolution of the image processing module at which the first amount of image data and the subset of the second amount of image data are received; and
the third resolution is equal to a recording resolution at which the first amount of image data is recorded as a video recording comprising the set of images.

4. The system of claim 3, wherein the third resolution is equal to the recording resolution at which the subset of the second amount of image data is recorded as the detail frame, the detail frame included in the video recording.

5. The system of claim 1, wherein the detail subject to be captured by the detail frame is determined by an object identification module associated with the image sensor controller, the object identification module configured to:
obtain one or more images from the set of images, the one or more images generated from the first amount of image data;
identify one or more objects of interest captured by the one or more images; and
determine, from the one or more objects of interest, a first object of interest as the detail subject.

6. The system of claim 5, the object identification module further configured to:
determine, for the detail subject and based on the one or more images, an object position of the first object of interest within the first amount of image data; and
generate, based at least on the object position, one or more image coordinates associated with the first resolution corresponding to the object position.

7. The system of claim 1, wherein determining the detail boundary comprises:
determining, by a processor associated with the image sensor controller, an object position associated with the detail subject within the set of images; and
determining, by the processor and based at least on the object position, the detail boundary as a bounding box that encompasses at least the object position in the first amount of image data.

8. The system of claim 1, wherein the first filter modifies the first amount of data from the first resolution to the second resolution by binning the first amount of data at the first resolution to provide the first amount of data at the second resolution.

9. The system of claim 1, wherein the second filter crops the second amount of data at the first resolution to obtain the subset of the second amount of data at the second resolution.

10. The system of claim 1, wherein the image processing module is associated with an image processing module configuration that is utilized for converting the first amount of image data at the second resolution and the subset of the second amount of image data at the second resolution to a video recording at the third resolution.

11. A method for capturing a detail frame by a recording device, the method comprising:
determining, for an image sensor of the recording device, a first sensor configuration comprises at least a first resolution and a first mode;
capturing, based at least on the first sensor configuration, a first amount of image data at the first resolution;
providing the first amount of image data, at a second resolution, to an image processing module;
causing the image processing module to generate a set of images from the first amount of image data and record the set of images;
determining a detail boundary associated with a detail subject to be captured by the detail frame;
determining, based at least on the detail boundary, a second sensor configuration comprising at least the second resolution and a second mode;
capturing, by the image sensor of the recording device, a second amount of image data at the second resolution; and
providing, to the image processing module, the second amount of image data to generate the detail frame.

12. The method of claim 11, wherein the first mode is a binning enabled mode, the first mode causing the image sensor to modify the first amount of image data from the first resolution to the second resolution.

13. The method of claim 11, wherein:
the second sensor configuration comprises a binning disabled indication, a capture offset, and a set of capture dimensions; and
the second sensor configuration causes the second amount of image data to be captured at the second resolution.

14. The method of claim 11, wherein capturing the first amount of image data comprises:
determining, based at least on the first sensor configuration, a set of photoreceptors from the image sensor associated with the first resolution;
capturing, via the set of photoreceptors, the first amount of image data at the first resolution; and
modifying, based at least on the first mode of the first sensor configuration, the first amount of image data from the first resolution to the second resolution.

15. The method of claim 14, wherein capturing the second amount of image data comprises:
determining, based at least on the second sensor configuration, an additional set of photoreceptors from the image sensor associated with the second resolution; and
capturing, via the additional set of photoreceptors, the second amount of image data at the first resolution.

16. A recording device, comprising:
an image sensor configured to capture optical data at a first resolution;
an image processing module configured to record one or more images from the optical data and receive the optical data at a second resolution;
a non-transitory computer-readable storage medium storing computer-readable instructions; and
an image processor communicatively coupled to the image sensor, the image processor, and the non-transitory computer-readable storage medium, the processor further configured to execute the computer-readable instructions, wherein the computer-readable instructions, when executed, cause the processor to perform operations comprising:
capturing, via the image sensor, the optical data;
recording, via the image processing module, the one or more images, the one or more images generated from the optical data by the image processing module;
receiving an input to generate a detail frame from additional optical data;
determining a detail subject to be captured within the detail frame;
determining, based at least on the detail subject, one or more image coordinates for the detail frame that encompass the detail subject within the one or more images; and
providing, to the image processing module, the additional optical data to generate the detail frame, the additional optical data obtained by the image sensor from within the one or more image coordinates.

17. The recording device of claim 16, wherein:
the image sensor converts the optical data from the first resolution to the second resolution based at least on an image sensor configuration; and
the image sensor configuration comprises a binning enabled configuration such that the image sensor converts the optical data from the first resolution to the second resolution by combining a plurality of pixel sets of the optical data at the first resolution to generate a plurality of pixels of the optical data at the second resolution.

18. The recording device of claim 16, wherein:
the image sensor captures the additional optical data at the second resolution based at least on a detail frame configuration, the detail frame configuration determined based at least on the one or more image coordinates; and
the detail frame configuration comprises at least a capture offset and the second resolution.

19. The recording device of claim 16, wherein the image processing module is associated with a module configuration that enables generation of the one or more images and the detail frame based at least on the second resolution.

20. The recording device of claim 19, wherein the optical data is processed by a first image processing pipeline and the additional optical data is processed by a second image processing pipeline, the first image processing pipeline and the second image processing pipeline sharing the module configuration.
